(19) United States
(12) Patent Application Publication
(10) Pub. No.: US 2015/0287299 A1
(43) Pub. Date: Oct. 8, 2015

(54) SECURITY DEVICE WITH FLEXIBLE STRIP

(71) Applicant: Checkpoint Systems, Inc., Thorofare, NJ (US)

(72) Inventors: Lee H. Eckert, Waxhaw, NC (US); David P. Christianson, Charlotte, NC (US); Adam Mark Will, Fort Mill, SC (US); Matthew R. Shute, Huntersville, NC (US); William J. Kozlowski, Waxhaw, NC (US)

(21) Appl. No.: 14/375,736

(22) PCT Filed: Jan. 31, 2013
(86) PCT No.: PCT/US13/24153

§ 371 Date: Jul. 30, 2014

Related U.S. Application Data
(60) Provisional application No. 61/592,936, filed on Jan. 31, 2012.
(60) Provisional application No. 61/601,163, filed on Feb. 21, 2012.

(51) Int. Cl. G08B 13/14

(52) U.S. Cl. CPC G08B 13/1409

(57) ABSTRACT

Anti-theft device and a method of operating and using the device are provided. The security device may include a housing and a disposable tamper strip which is configured to attach to a merchandise item or other article. The tamper strip may include a conductor such that when the conductor is severed, an alarm is sounded. The tamper strip may include tear points which encourage the conductor to be torn, such as when a potential thief attempts to remove the device from the merchandise item or other article.

This application claims priority from U.S. Provisional Application Ser. No. 61/592,936, filed Jan. 31, 2012, as well as U.S. Provisional Application Ser. No. 61/601,163, filed Feb. 21, 2012; the disclosures of which are incorporated herein by reference.

### BACKGROUND OF THE INVENTION

There exist many anti-theft devices for use with a wide range of commercial products wherein the anti-theft device may contain an electronic article surveillance (EAS) tag and/or an onboard alarm. EAS tags are configured to cause an audible alarm to sound at an exit gate of a store or the like to alert store personnel to a potential theft. These devices are easily and quickly attached to an article and subsequently removed by an authorized clerk from the article after a sale. Some security devices, such as pin tags, have a pin or sharp protrusion which pierces or punctures the item to which it is attached, while devices do not, thereby avoiding any damage to the article. Pin tags and the like are particularly inappropriate for use with certain articles, such as expensive shoes formed of leather or other types of merchandise items. Further, there are some drawbacks to various devices in the art which do not puncture or pierce merchandise items. Therefore, a need exists in the art for a security device which avoids such piercing or puncturing and which overcomes these drawbacks.

### SUMMARY OF THE INVENTION

In one aspect of the invention, an anti-theft tamper strip may include an adhesive for affixing the anti-theft tamper strip to an article to be protected; an electrical conductor, wherein the electrical conductor includes two contact areas positioned to electrically connect to respective contacts of an alarming module; and a plurality of tear points formed in the tamper strip to encourage the electrical conductor to be torn upon application of a removal force on the flexible strip.

In another aspect of the invention, a security device for protecting an article from theft may include a housing; a first electrical conductor in the housing having a first electrical contact; a flat flexible tamper strip having an attached position in which the tamper strip is secured to and extends outwardly from the housing, and a detached position in which the tamper strip is separated from the housing; and a second electrical conductor of the tamper strip having a second electrical contact which contacts the first electrical contact in the attached position.

In a further aspect of the invention, an apparatus may include a housing; two electrical contacts mounted on the housing and positioned such that the two electrical contacts connect with respective complementary contact areas of a disposable tamper strip, wherein the disposable tamper strip is configured to be adhered to an article to be protected from theft and wherein the tamper strip includes an electrical conductor that is electrically connected to at least one of the contact areas; and processing circuitry which is configured to detect an electrical discontinuity between the two electrical contacts, wherein the electrical discontinuity between the two electrical contacts occurs due to a severing of the electrical conductor of the tamper strip; and wherein the processing circuitry is configured to trigger a local alarm in response to detecting the electrical discontinuity.

In an additional aspect of the invention, a method may include positioning a disposable tamper strip to connect two contact areas of the tamper strip to two electrical contacts mounted on a housing, wherein the tamper strip is configured to be adhered to an article to be protected from theft and wherein the tamper strip includes an electrical conductor that is electrically connected to at least one of the contact areas; detecting with processing circuitry an electrical discontinuity between the two electrical contacts, wherein the electrical discontinuity occurs due to a severing of the electrical conductor of the tamper strip; and triggering with the processing circuitry a local alarm in response to detecting the electrical discontinuity.

In another aspect of the invention, a method may include applying an anti-theft tamper strip to an article to be protected by affixing an adhesive of the tamper strip to the article; wherein the tamper strip comprises: the adhesive; an electrical conductor, wherein the electrical conductor includes two contact areas positioned to electrically connect to respective contacts of an alarming module; and a plurality of tear points formed in the tamper strip to encourage the electrical conductor to be torn upon application of a removal force on the flexible strip.

### BRIEF DESCRIPTION OF SEVERAL VIEWS OF THE DRAWINGS

One or more example embodiments that illustrate at least the best mode are set forth in the drawings and in the following description. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the Figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a perspective view of an example embodiment of a security device with an example of a flexible strip attached to a merchandise item in the form of a shoe.

FIG. 2 is a perspective view of an example embodiment with the an example flexible strip not attached to a merchandise item.

FIG. 3 is a perspective view of an example flexible strip.

FIG. 3A is a top plan view of an example flexible strip.

FIG. 4 is an exploded perspective view of an example flexible strip.

FIG. 5 is a perspective view of the bottom of an example flexible strip with the peel-off strips in the process of being removed from the adhesive layers.

FIG. 6 is a diagrammatic view showing the relationship between FIGS. 6A and 6B.

FIG. 6A is an exploded view of the upper portion of the housing, alarm system and related components.

FIG. 6B is an exploded view of the lower portion of the housing and the door with a portion of an example flexible strip shown in phantom.

FIG. 7 is a bottom perspective view of a housing door.

FIG. 8 is a bottom perspective view of a lower housing portion.

FIG. 9 is a bottom perspective view of a upper housing portion.

FIG. 10 is a cross-sectional view taken from the side showing an example flexible strip entering a housing with the door in the open position.

FIG. 11 is similar to FIG. 10 showing the door moved to the closed position with the tab of the door received in a hole in an example flexible strip.

FIG. 12 is a cross-sectional view similar to FIGS. 10 and 11 with the door closed and the contacts pressing on a flexible strip conductor.

FIG. 13 is a cross-sectional view taken from the side and showing a door in the closed position and a locking pin in a locked position.

FIG. 14 is similar to FIG. 13 and shows the housing door in a closed position and with a locking pin in an unlocked position.

FIG. 15 is a cross sectional view taken from the side and showing a rear portion of the housing of an example embodiment of the security device with a modified strip retainer in a closed position and a lock in a locked position.

FIG. 16 is similar to FIG. 15 showing the second embodiment with the strip retainer in an open position and the lock in an unlocked position.

FIG. 17 is a perspective view of an example embodiment of a security device with a housing attached to a strip retainer which is secured to a box.

FIG. 18 is similar to FIG. 17 and shows a housing detached from a strip retainer.

FIG. 19 is a top plan view of a flexible strip.

FIG. 20 is a sectional view taken on line 20-20 of FIG. 19 showing various layers of a flexible strip.

Similar numbers refer to similar parts throughout the drawings.

### DETAILED DESCRIPTION

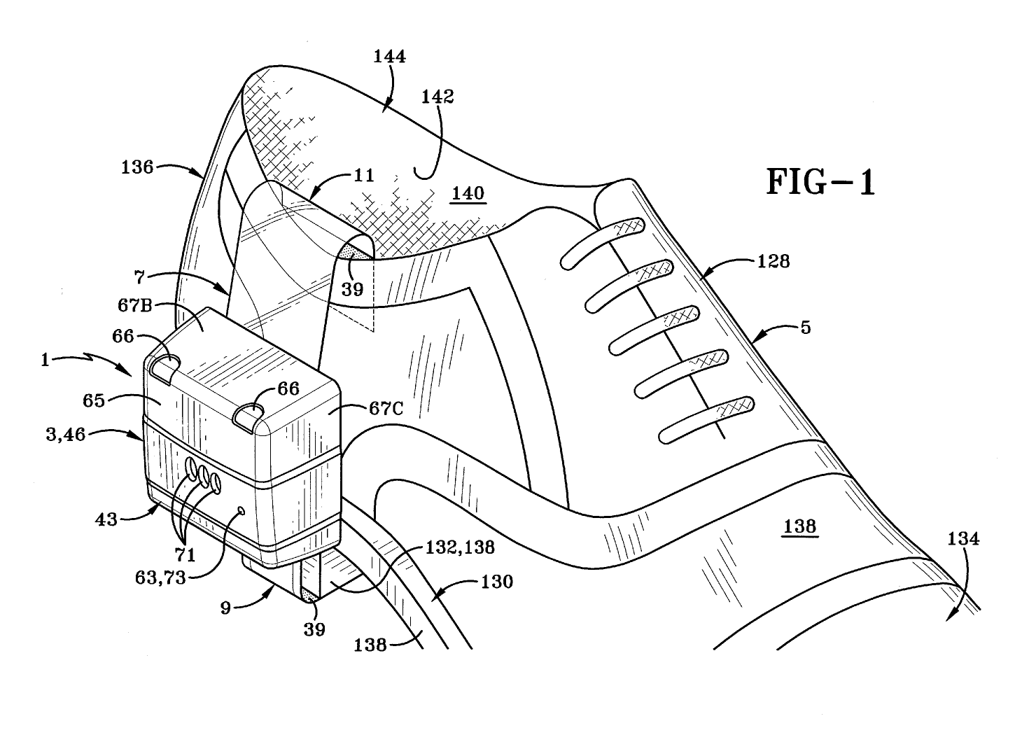

FIG. 1 illustrates an example embodiment of a security device 1 that may be easily attached to a merchandise item or other article for the prevention of theft of the item or article in a retail setting. The main components of the security device 1 include an alarming module, which comprises a housing 3, and a disposable thin flat flexible security or tamper strip 7. According to various example embodiments, the security strip 7 may be constructed in various forms including, but not limited to, a sheet, tape, or the like. Strip 7 has first and second ends, or front and rear ends 9 and 11 respectively, between which strip 7 is elongated and which define therebetween a longitudinal direction of strip 7. Strip 7 has first and second sides 12 and 14 defining therebetween an axial direction of strip 7. The longitudinal and axial directions apply also to device 1 and housing 3. Strip 7 has an upwardly facing top surface 7A and a downwardly facing bottom surface 7B defining therebetween a thickness which in an example embodiment, may, but need not be a few mils (thousandths of an inch) thick. In use, strip 7 is attached to a merchandise item such as a shoe 5 (FIG. 1) that is to be protected from theft, with, for example, first end 9 secured to an exterior portion of shoe 5 such as the bottom of the heel and second end 11 secured to an interior portion of shoe 5. If housing 3 is removed from strip 7 without using an authorized key or if strip 7 is torn, the security device 1 may generate an alarm.

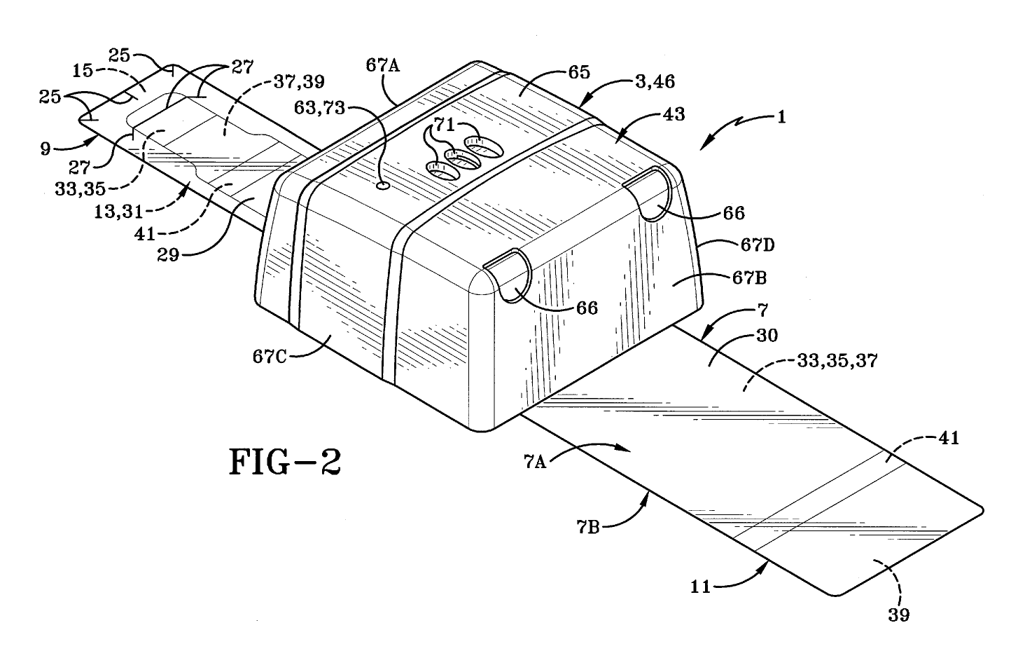

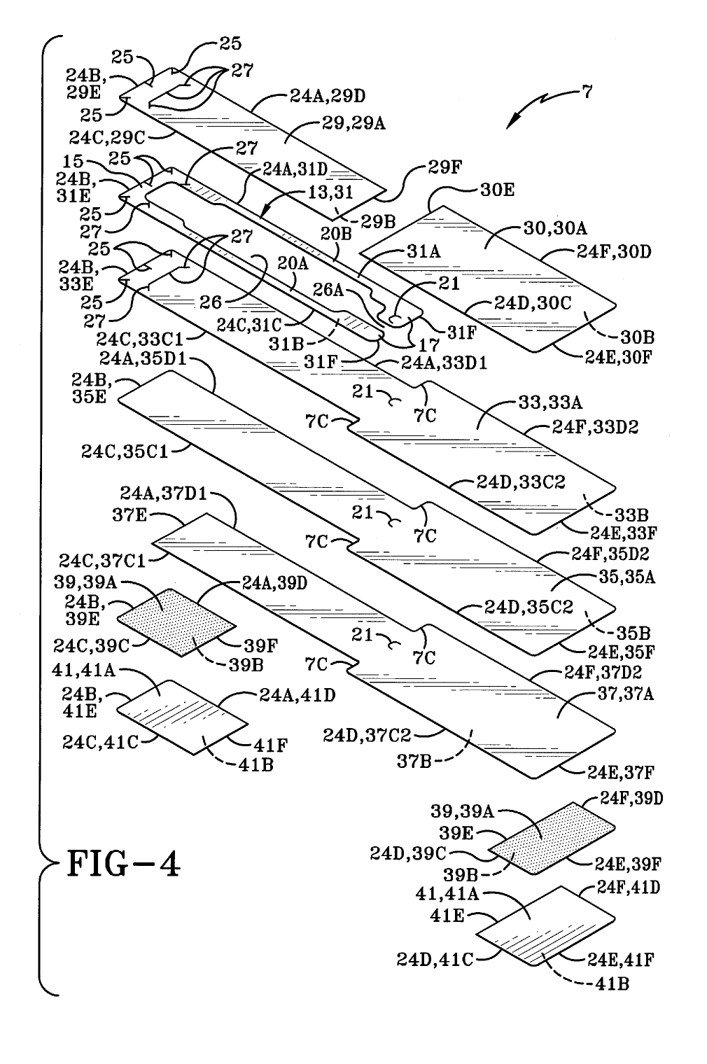

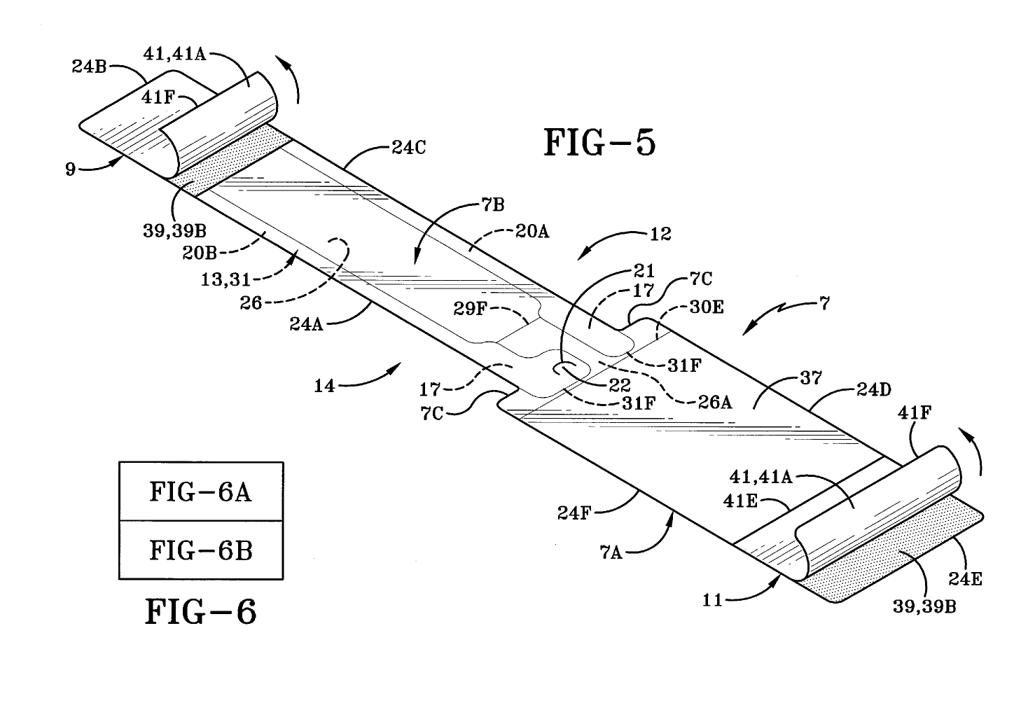

With reference to FIGS. 2-5, strip 7 may be formed with two or more layers and may include one or more electrical conductors 13 that may extend between first end 9 and a central or intermediate portion 10 of strip 7. Conductor 13 may be a conductive trace that is deposited on one or two or more layers forming strip 7. According to some example embodiments, a conductive trace may be formed by depositing a conductive ink on one or more of the layers. In some example embodiments, conductor 13 may be U-shaped, thus forming an open loop. Conductor 13 may include an axially elongated base 15 along first end 9 and left and right longitudinally elongated legs 20A and 20B which are connected to the left and right ends of base 15 and extend longitudinally rearward toward second end 11, terminating at respective endpoints 17 within intermediate portion 10. Endpoints 17 serve as contacts or contact areas. Inasmuch as electrical conductor 13 is electrically continuous from one endpoint/contact area 17 to the other endpoint/contact area 17, conductor 13 is electrically connected to both of contact areas 17 and there is electrical continuity from one endpoint/contact area 17 to the other endpoint/contact area 17. Legs 20A and 20B may be axially spaced from one another and thus may define therebetween a longitudinally elongated space 26 which extends from the rear or back of base 15 to the rear ends of legs 20. Space 26 may be surrounded by conductor 13 as viewed from above except at an entrance opening 26A defined between endpoints 17. U-shaped conductor 13 thus begins and ends in portion 10 at the respective endpoints 17. Strip 7 may include a front narrower portion 6 that extends from central portion 10 to first end 9 and a rear wider portion 8 that extends from central portion 10 to second end 11. Two axially extending edges or shoulders or stops 7C may be formed adjacent front corners of wider portion 8 near where wider portion 8 meets narrower portion 6 at central portion 10.

Strip 7 has a continuous outer perimeter 24 which defines the shape of strip 7 as viewed from above. Outer perimeter 24 includes outer perimeter edges 24A-F and edges or shoulders 7C. Edges 24B and 24E are respectively axially extending front and rear end edges of strip 7 which in the exemplary embodiment are parallel and define therebetween a length L1 which is the total length of strip 7. Edges or shoulders 7C serve as axially extending front end edges of wider portion 8 whereas edge 24E serves as a rear end edge of wider portion 8. End edges 7C and 24E define therebetween a length L2 of wider portion 8 which may be substantially less than length L1, and in the exemplary embodiment less than ½ length L1 and greater than ⅓ length L1 although this may vary. End edges 7C, or the line along which end edges 7C lie, define a rear end of narrower portion 6. End edges 7C and front end edge 24B define therebetween a length L3 which is substantially less than length L1, and in the exemplary embodiment a little more than ½ length L1 and less than ⅔ length L1, although this may vary. In the exemplary embodiment, length L3 is greater than length L2 although they may be equal or length L3 may be less than length L2.

Edges 24D and 24F are longitudinally extending side edges of wider portion 8 which in the exemplary embodiment are parallel and define therebetween a first width W1 of wider portion 8. Edges 24A and 24C are longitudinally extending side edges of narrower portion 6 which in the exemplary embodiment are parallel and define therebetween a second width W2 of narrower portion 6. Second width W2 is thus less than first width W1. In the exemplary embodiment, side edges 24A, 24C, 24D and 24F are parallel to one another and perpendicular to edges 24A, 24E and 7C. Each of narrower and wider sections 6 and 8 is thus essentially rectangular as viewed from above. In the exemplary embodiment, width W1 is constant from adjacent the front end of section 8 to adjacent the back end of section, and width W2 is likewise constant from adjacent the front end of section 6 to the back end of section 6.

An alignment or locating opening or hole 21 may be formed in strip 7 extending from top surface 7A to bottom surface 7B. Alignment hole 21 is here formed by a small U-shaped precut or slit such that a U-shaped flap 22 defined by the slit can move up or down relative to the portion of strip 7 surrounding flap 22 to open hole 21 beyond the slit. Hole 21 may be adjacent the back end of narrower portion 6, the front end of wider portion 8 and shoulders 7C. Hole 21 is shown axially midway across strip 7 substantially directly between shoulders 7C.

A plurality of tear points 25 and/or 27 are shown formed in strip 7 in a manner to facilitate or encourage, upon tampering, strip 7 to be torn and in particular for conductor 13 to be torn all the way across a given segment thereof such as base 15 or one of legs 20 thereby breaking conductivity between contacts or contact areas 17. More particularly, tear points 25 and/or 27 encourage the tearing of strip 17 and conductor 13 upon application of a removal force such as a pulling or stretching force on strip 7, such as when a potential thief attempts to peel strip 7 off of the merchandise item, or more broadly attempts to forcefully remove strip 7 from the merchandise item or housing 3 by pulling and/or twisting strip 7 directly, or indirectly by pulling and/or twisting housing 3 when strip 7 is secured to housing 3. Tear points 25 and 27 may be, for example, in the form of slits, cuts, notches or another form which decreases a thickness of strip 7 relative to the thickness of strip 7 immediately adjacent the decreased thickness. For example, a tear point may be a crimp or crimped tear point created by crimping strip 7 to produce such a decreased thickness. Tear points 25 and 27 may be precuts or slits which are formed in strip 7 adjacent conductor 13 and which extend from top surface 7A to bottom surface 7B, or the precuts may be formed in only some of the layers making up strip 7 such that the precut or slit extends only partially through the thickness of strip 7. Precuts form only one option for generating tear points 25 and 27. Other options may include mechanically weakened areas that are generated by changes in the material of the strip, changes in the thickness of the strip, or the like. Such a mechanically weakened area may include a first material of the strip and a second different material of the strip adjacent the first material. A change in thickness may be created in various ways, including using a different number of layers in one portion of strip 7 than in another adjacent portion of strip 7.

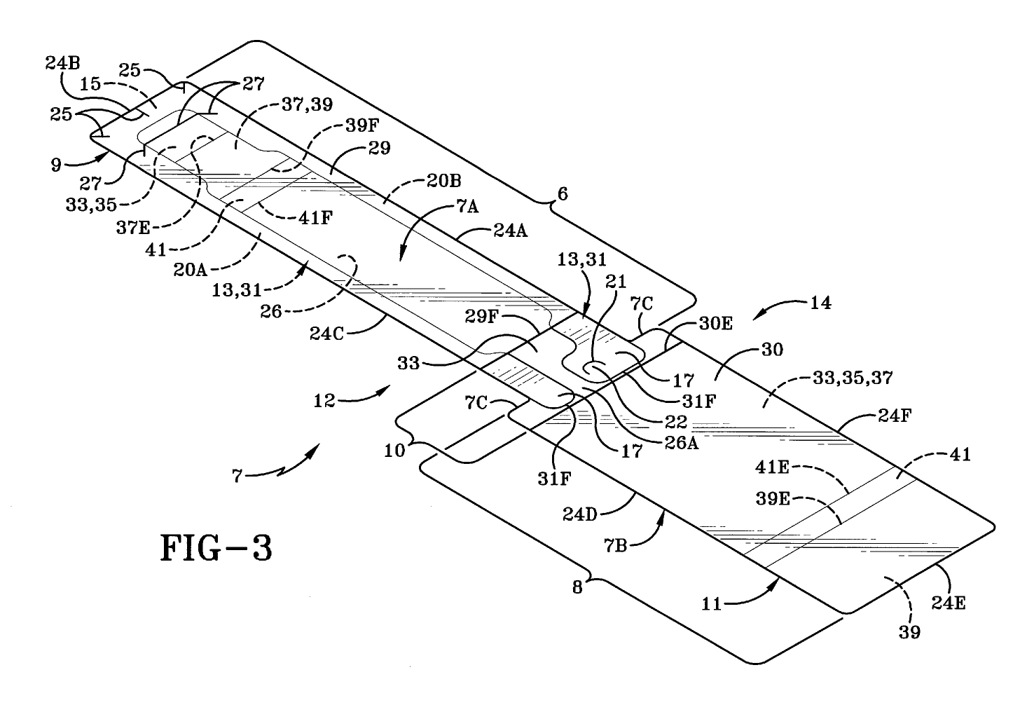

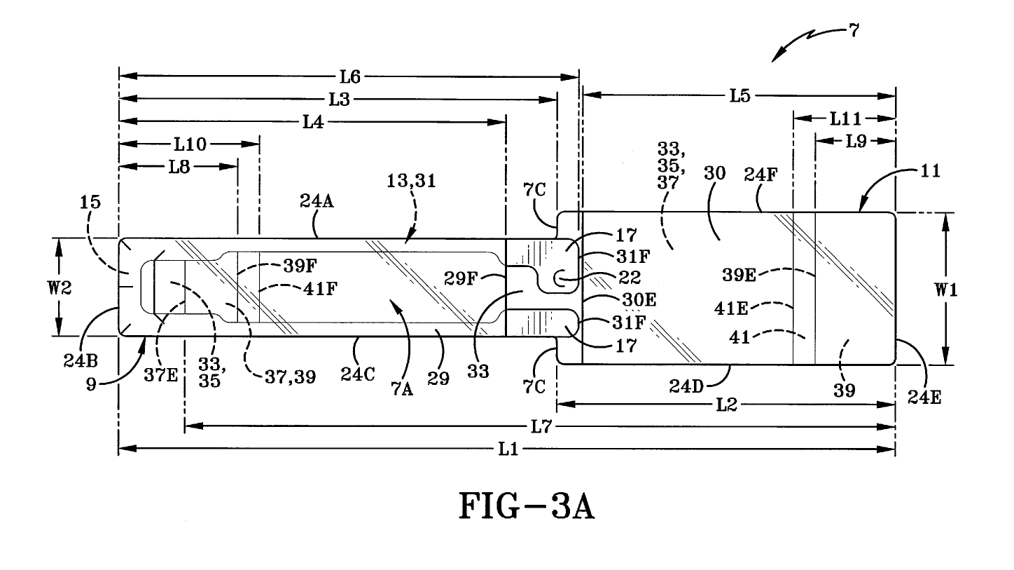

Tear points 25 are described here as exterior tear points or slits 25 which are cut in strip 7 to extend inward from outer perimeter 24 a short distance, thus terminating adjacent outer perimeter 24. Each slit 25 has an outer end at outer perimeter 24 and an inner terminal end in base 15 or one of legs 20 of conductor 13. Slits 25 are adjacent first end 9 and extend inwardly from edges 24A, 24B and/or 24C. FIG. 3 shows one slit 25 extending longitudinally inwardly from edge 24B about midway between and parallel to edges 24A and 24C, while two of slits 25 extend inwardly from respective rounded corners formed by the intersections between edge 24B and each of edges 24A and 24C. The two corner slits and other slits may be angled and thus extend longitudinally and axially inward at about a 45-degree angle relative to edges 24A-C. Slits 25 extend inward from outer perimeter 24 and the respective edge part way, but not all the way across or through conductor 13. Tear points 25 may extend into conductor 13.

Tear point 27 is described here as an interior tear point, precut or slit 27 which is formed primarily within the U-shaped conductor 13 and does not extend to outer perimeter 24. Slit 27 extends primarily axially and extends across more than half of width W2 of narrower portion 6. Slit 27 has a main central section which is a straight axial section extending parallel to edge 24B from adjacent the inside of leg 20A to adjacent the inside of leg 20B. Slit 27 further includes shorter terminal sections which extend respectively at an angle of about 45 degrees from the left and right ends of the central section. Each of the terminal sections extends part way, but not all the way across or through conductor 13 respectively in legs 20A and 20B. Each of the terminal sections of slit 27 thus defines a terminal end of slit 27 which is adjacent or within conductor 13 and may be within legs 20 of conductor 13. Tear points 27 may extend into conductor 13.

As shown in FIG. 4, strip 7 is formed of several flat flexible sheets or layers, which may vary although in the exemplary embodiment, the layers include a front upper dielectric or insulation layer 29, a rear upper dielectric or insulation layer 30, an electrically conductive layer 31 serving as conductor 13, a middle dielectric or insulation layer 33, a dielectric strengthening layer 35, a lower dielectric or insulation layer 37, front and rear adhesive layers 39 and front and rear backing layers or peel-off strips 41. Layers 29 and 33 are conductor-contacting layers which contact layer 31/conductor 13 whereas layers 30, 35, 37, 39 and 41 do not contact layer 31/conductor 13. Depending on the material of which the various layers are formed, strengthening layer 35 or an alternate strengthening layer may be needed to improve the ability of security device 1 to absorb forces when it is dropped onto a floor or other hard surface inasmuch as housing 3 may break off of strip 7 and generate an alarm absent the presence of strip 35. Conductive layer 31 may be said to be formed on or secured to a substrate comprising two or more layers such as layers 29, 30, 33, 35 and/or 37. This substrate is mechanically stronger than conductive layer 31 whereby tearing conductive layer 31 is easier than tearing the substrate. Any one of layers 29, 30, 33, 35 and 37 may be mechanically stronger than conductive layer 31 whereby tearing conductive layer 31 is easier than tearing any of these layers. Strip 7 is constructed to balance conflicting objectives. That is, strip 7 is robust and durable so that when flexed with the weight of housing 3 and/or sharply impacted such as when dropped on a floor, strip 7 will not tear or otherwise break such that conductor 13 is torn through or severed, which would trigger a false alarm; at the same time, strip 7 has a frangible/tear-away section so that an alarm is triggered when an attempt is made to defeat device 1.

Each of the layers of strip 7 has a flat upwardly facing top surface and a parallel flat downwardly facing bottom surface. Each of these top and bottom surfaces extends continuously from the left and right edges of the given layer and continuously from the front and rear edges of the given layer. In particular, layer 29 has top and bottom surfaces 29A and 29B, layer 30 has top and bottom surfaces 30A and 30B, layer 31 has top and bottom surfaces 31A and 31B, layer 33 has top and bottom surfaces 33A and 33B, layer 35 has top and bottom surfaces 35A and 35B, layer 37 has top and bottom surfaces 37A and 37B, each layer 39 has top and bottom surfaces 39A and 39B, and each layer 41 has top and bottom surfaces 41A and 41B.

Dielectric layer 29 is rectangular as viewed from above and has straight longitudinally extending parallel left and right edges 29C and 29D and straight axially extending parallel front and rear edges 29E and 29F which are perpendicular to and intersect edges 29C and 29D at respective corners. Edges 29E and 29F define therebetween a length L4 of layer 29 which is about ½ length L1 although this may vary. Edges 29C and 29D define therebetween a width which is equal to or about equal to width W2 of narrower section 6. Left edge 29C may form part of or be closely adjacent left edge 24C. Right edge 29D may form part of or be closely adjacent right edge 24A. Front edge 29E may form part of or be closely adjacent front edge 24B. Rear edge 29F may extend all the way across narrower section 6 adjacent and forward of shoulders 7C.

Dielectric layer 30 is rectangular as viewed from above and has straight longitudinally extending parallel left and right edges 30C and 30D and straight axially extending parallel front and rear edges 30E and 30F which are perpendicular to and intersect edges 30C and 30D at respective corners. Edges 30E and 30F define therebetween a length L5 of layer 30. Length L5 may be less than ½ length L1 and greater than ⅓ length L1 although this may vary. Length L5 is less than length L2 and greater than ¾ length L2 although this may vary. Edges 30C and 30D define therebetween a width which is equal to or about equal to width W1 of wider section 8. Left edge 30C may form part of or be closely adjacent left edge 24D. Right edge 30D may form part of or be closely adjacent right edge 24F. Front edge 30E may extend all the way across wider section 8 adjacent and rearward of shoulders 7C and rear endpoints 17 of conductor 13. Rear edge 30F may form part of or be closely adjacent rear edge 24E. Front edge 30E and rear edge 29F of layer 29 define therebetween central or intermediate area or portion 10, which may be also understood as an open or exposed area which exposes endpoints 17 and a portion of top surface 33A of layer 33 between endpoints 17 along the rear of narrower section 6 and the front of wider section 8, to the left of left leg 20A along the front of wider section 8 and to the right of right leg 20B along the front of wider section 8. Conductor 13/layer 31 may extend from adjacent front end 9 and edge 24B to adjacent intermediate section 10. Conductor 13/layer 31 extends between layers 29 and 33 and has a covered portion between the layers 29 and 33 and an exposed portion in section 10 which is not between the layers 29 and 33.

Conductive layer 31 is U-shaped as viewed from above and has straight longitudinally extending parallel left and right edges 31C and 31D, a straight axially extending front edge 31E and an axially extending rear edge 31F wherein edges 31E and 31F are generally perpendicular to edges 31C and 31D. Left edge 31C is the left edge of left leg 20A, and right edge 31D is the right edge of right leg 20B. Rear edge 31F is formed as two segments, namely the respective rear edges of legs 20A and 20B or endpoints 17. Front edge 31E may be referred to as a front extent end of conductor 13/layer 31 and rear edge 31F may be referred to as a rear extent end of conductor 13/layer 31 to make a distinction relative to the electrical ends or endpoints 17 since, for example, the electrical ends are adjacent rear extent end 31F. Edges or extent ends 31E and 31F define therebetween a length L6 of layer 31. Length L6 is similar to and a little greater than length L3 of narrow section 6 although this may vary. Length L4 of layer 29 is less than length L6 and may be more than ½ or ¾ length L6. Edges 31C and 31D define therebetween a width which is equal to or about equal to width W2 of narrower section 6. Thus, each leg 20 has a width which is less than width W2. Left edge 31C may form part of or be closely adjacent left edge 24C. Right edge 31D may form part of or be closely adjacent right edge 24A. Front edge 31E may form part of or be closely adjacent front edge 24B. Rear edge 31F extends partially across wider section 8 adjacent and rearward of shoulders 7C and rear end 29F of layer 29, and adjacent and forward of front edge 30E of layer 30. Rear edge 31F is thus adjacent and rearward of the front end of wider section 8 and the rear end of narrower section 6. Rear edge 31F may be in or adjacent intermediate section 10 and may be between and distal front ends 9 and 11 and is likewise between and distal front and rear end edges 24B and 24E.

Dielectric layer 33 has the same shape as strip 7 overall as viewed from above and as previously described. Layer 33 thus has narrower and wider sections respectively analogous to sections 6 and 8 and having the same shape and size, respectively. The narrower section of layer 33 has straight longitudinally extending parallel left and right edges 33C1 and 33D1, while the wider section of layer 33 has straight longitudinally extending parallel left and right edges 33C2 and 33D2 which are parallel to edges 33C1 and 33D1. Layer 33 has straight axially extending parallel front and rear edges 33E and 33F which are perpendicular to edges 33C and 33D, with front edge 33E intersecting left and right edges 33C1 and 33D1 at respective front corners of layer 33, and with rear edge 33F intersecting left and right edges 33C2 and 33D2 at respective rear corners of layer 33. Front edge 33E may form part of or be closely adjacent front edge 24B. Rear edge 33F may form part of or be closely adjacent rear edge 24E. Edges 33E and 33F define therebetween a length of layer 33 which is equal to or nearly equal to length L1. Left edge 33C1 may form part of or be closely adjacent left edge 24C. Right edge 33D1 may form part of or be closely adjacent right edge 24A. Edges 33C1 and 33D1 define therebetween a width which is equal to or about equal to width W2 of narrower section 6. Left edge 33C2 may form part of or be closely adjacent left edge 24D. Right edge 33D2 may form part of or be closely adjacent right edge 24F. Edges 33C2 and 33D2 define therebetween a width which is equal to or about equal to width W1 of wider section 8. The wider section of layer 33 thus also has a length from rear edge 33F to shoulders 7C which is equal to or nearly equal to length L2 of wider section 8. Likewise, the narrower section of layer 33 also has a length from front edge 33E to shoulders 7C which is equal to or nearly equal to length L3 of narrower section 6.

Dielectric layer 35 has the same shape as layer 33 and strip 7 overall as viewed from above. Layer 35 thus has narrower and wider sections respectively analogous to sections 6 and 8 and having the same shape and size, respectively. The narrower section of layer 35 has straight longitudinally extending parallel left and right edges 35C1 and 35D1, while the wider section of layer 35 has straight longitudinally extending parallel left and right edges 35C2 and 35D2 which are parallel to edges 35C1 and 35D1. Layer 35 has straight axially extending parallel front and rear edges 35E and 35F which are perpendicular to edges 35C and 35D, with front edge 35E intersecting left and right edges 35C1 and 35D1 at respective front corners of layer 35, and with rear edge 35F intersecting left and right edges 35C2 and 35D2 at respective rear corners of layer 35. Front edge 35E may form part of or be closely adjacent front edge 24B. Rear edge 35F may form part of or be closely adjacent rear edge 24E. Edges 35E and 35F define therebetween a length of layer 35 which is equal to or nearly equal to length L1. Left edge 35C1 may form part of or be closely adjacent left edge 24C. Right edge 35D1 may form part of or be closely adjacent right edge 24A. Edges 35C1 and 35D1 define therebetween a width which is equal to or about equal to width W2 of narrower section 6. Left edge 35C2 may form part of or be closely adjacent left edge 24D. Right edge 35D2 may form part of or be closely adjacent right edge 24F. Edges 35C2 and 35D2 define therebetween a width which is equal to or about equal to width W1 of wider section 8. The wider section of layer 35 thus also has a length from rear edge 35F to shoulders 7C which is equal to or nearly equal to length L2 of wider section 8. Likewise, the narrower section of layer 35 also has a length from front edge 35E to shoulders 7C which is equal to or nearly equal to length L3 of narrower section 6.

Dielectric layer 37 has a shape which is very similar to the shape of layers 33 and 35 and strip 7 overall as viewed from above. Layer 37 has a wider section analogous to and having the same shape and size as wider section 8. Layer 37 also has a narrower section analogous to narrower section 6 having a similar shape and size except that the narrower section of layer 37 is a little shorter than narrower section 6. The narrower section of layer 37 has straight longitudinally extending parallel left and right edges 37C1 and 37D1, while the wider section of layer 37 has straight longitudinally extending parallel left and right edges 37C2 and 37D2 which are parallel to edges 37C1 and 37D1. Layer 37 has straight axially extending parallel front and rear edges 37E and 37F which are perpendicular to edges 37C and 37D, with front edge 37E intersecting left and right edges 37C1 and 37D1 at respective front corners of layer 37, and with rear edge 37F intersecting left and right edges 37C2 and 37D2 at respective rear corners of layer 37. Front edge 37E is generally adjacent and rearward of front edge 24B and slits 25 and 27 and may extend all the way across the narrower section of layer 37. Rear edge 37F may form part of or be closely adjacent rear edge 24E. Edges 37E and 37F define therebetween a length of layer 37 which may be a little less than length L1, greater than ¾ length L1 and substantially greater than each of lengths L2, L3, L4, L5 and L6. Left edge 37C1 may form part of or be closely adjacent left edge 24C. Right edge 37D1 may form part of or be closely adjacent right edge 24A. Edges 37C1 and 37D1 define therebetween a width which is equal to or about equal to width W2 of narrower section 6. Left edge 37C2 may form part of or be closely adjacent left edge 24D. Right edge 37D2 may form part of or be closely adjacent right edge 24F. Edges 37C2 and 37D2 define therebetween a width which is equal to or about equal to width W1 of wider section 8. The wider section of layer 37 thus also has a length from rear edge 37F to shoulders 7C which is equal to or nearly equal to length L2 of wider section 8. The narrower section of layer 37 has a length from front edge 37E to shoulders 7C which is less than length L3 of narrower section 6 and may be greater than ¾ length L3.

Layers 33, 35 and 37 overlap one another over a substantial portion of strip 7 although layers 33 and 35 do not overlap layer 37 adjacent front end 9 forward of edge 37E and rearward of edges 33E, 35E, 24B since edge 37E is spaced rearwardly of and adjacent edges 33E, 35E, 24B. Strengthening layer 37 does not extend to conductor 13 front extent end 31E. Thus, strip 7 comprises an overlapping portion which includes layers 33, 35 and 37 (where they overlap) and a non-overlapping portion which includes layers 33 and 35 and does not include layer 37 (where layer 37 does not overlap layers 33 and 35). The non-overlapping portion is adjacent front end 9 and extends forward from front end 37E to front end 24B and from side edge 24A to 24C. The non-overlapping portion is thinner than the overlapping portion. In the exemplary embodiment, tear points 25, 27 may be in the non-overlapping portion and thus not in strengthening layer 37.

Each of front and rear adhesive layers 39 is rectangular as viewed from above and has straight longitudinally extending parallel left and right edges 39C and 39D and straight axially extending parallel front and rear edges 39E and 39F which are perpendicular to and intersect edges 39C and 39D at respective corners. Front and rear edges 39E and 39F of front layer 39 define therebetween a length L8 which is substantially less than each of lengths L1, L2, L3, L4, L5, L6 and L7. Edges 39C and 39D of front layer 39 define therebetween a width which is equal to or about equal to width W2 of narrower section 6. Left edge 39C of front layer 39 may form part of or be closely adjacent left edge 24C. Right edge 39D of front layer 39 may form part of or be closely adjacent right edge 24A. Front edge 39E of front layer 39 may form part of or be closely adjacent front edge 24B. Rear edge 39F of front layer 39 may extend all the way across narrower section 6 generally adjacent front edge 24B and adjacent and rearward of front edge 37E of layer 37. Rear edge 39F is substantially closer to front edge 24B than to the rear end of narrower section 6, the front end of wider section 8 and shoulders 7C. All of front adhesive or adhesive layer 39 may be along front end 9 adjacent front edge 24B.

Front and rear edges 39E and 39F of rear layer 39 define therebetween a length L9 which is substantially less than each of lengths L1, L2, L3, L4, L5, L6 and L7. In the exemplary embodiment, length L9 is somewhat less than length L8 although they may be equal or length L9 may be less than length L8. Edges 39C and 39D of rear layer 39 define therebetween a width which is equal to or about equal to width W1 of wider section 8. Left edge 39C of rear layer 39 may form part of or be closely adjacent left edge 24D. Right edge 39D of rear layer 39 may form part of or be closely adjacent right edge 24F. Rear edge 39F of rear layer 39 may form part of or be closely adjacent rear edge 24E. Front edge 39E of rear layer 39 may extend all the way across wider section 8 generally adjacent rear edge 24E. Front edge 39E is substantially closer to rear edge 24E than to the front end of wider section 8, the rear end of narrower section 6 and shoulders 7C. All of rear adhesive or adhesive layer 39 may be along rear end 11 adjacent rear edge 24E.

Each peel-off strip or layer 41 is rectangular as viewed from above and has straight longitudinally extending parallel left and right edges 41C and 41D and straight axially extending parallel front and rear edges 41E and 41F which are perpendicular to and intersect edges 41C and 41D at respective corners. Front and rear edges 41E and 41F of front layer 41 define therebetween a length L10 of front layer 41 which is substantially less than each of lengths L1, L2, L3, L4, L5, L6 and L7. In the exemplary embodiment, length L10 is somewhat greater than length L8 of front adhesive layer 39 and should be equal to or more than length L8. Edges 41C and 41D of front layer 41 define therebetween a width which is equal to or about equal to width W2 of narrower section 6, and which should be equal to or more than the width of front adhesive layer 39. Left edge 41C of front layer 41 may form part of or be closely adjacent left edge 24C. Right edge 41D may form part of or be closely adjacent right edge 24A. Front edge 41E may form part of or be closely adjacent front edge 24B. Rear edge 41F may extend all the way across narrower section 6 generally adjacent front edge 24B and adjacent and rearward of slits 25 and 27, front edge 37E of layer 37 and rear edge 39F of adhesive layer 39. Rear edge 41F is substantially closer to front edge 24B than to the rear end of narrower section 6, the front end of wider section 8 and shoulders 7C. All of front peel-off strip or layer 41 may be along front end 9 adjacent front edge 24B.

Front and rear edges 41E and 41F of rear layer 41 define therebetween a length L11 of rear layer 41 which is substantially less than each of lengths L1, L2, L3, L4, L5, L6 and L7. In the exemplary embodiment, length L11 is somewhat greater than length L9 of rear adhesive layer 39 and should be equal to or more than length L9. Left and right edges 41C and 41D of rear layer 41 define therebetween a width which is equal to or about equal to width W1 of wider section 8, and which should be equal to or more than the width of rear adhesive layer 39. Left edge 41C of rear layer 41 may form part of or be closely adjacent left edge 24D. Right edge 41D of rear layer 41 may form part of or be closely adjacent right edge 24F. Rear edge 41F of rear layer 41 may form part of or be closely adjacent rear edge 24E. Front edge 41E of rear layer 41 may extend all the way across wider section 8 generally adjacent rear edge 24E and adjacent and forward of front edge 39E of rear adhesive layer 39. Front edge 41E of rear layer 41 is substantially closer to rear edge 24E than to the rear end of narrower section 6, the front end of wider section 8 and shoulders 7C. All of rear peel-off strip or layer 41 may be along rear end 11 adjacent rear edge 24E.

The various layers of strip 7 are attached to one another with the bottom surface of a given layer attached directly to the top surface of another layer or layers. Thus, bottom surface 31 B of conductor 31 is attached to top surface 33A of layer 33; bottom surface 29B of layer 29 is attached to top surface 31A of layer 31 and to a portion of top surface 33A of layer 33 between legs 20A and 20B; bottom surface 30B of layer 30 is attached to top surface 33A of wider portion 8 of layer 33; bottom surface 33B of layer 33 in its entirety is attached to top surface 35A of layer 35 in its entirety because layers 33 and 35 have the same shape and size; bottom surface 35B of layer 35 is attached to top surface 37A of layer 37 in its entirety, thus leaving a portion of bottom surface 35B adjacent front end 9 not attached to top surface 37A; top surface 39A of front layer 39 is attached to bottom surface 37B of narrower portion 6 of layer 37 adjacent front end 9 and to bottom surface 35B of narrower portion 6 of layer 35 adjacent front end 9; top surface 39A of rear adhesive layer 39 is attached to bottom surface 37B of wider portion 8 of layer 37 adjacent rear end 11; top surface 41A of front peel-off strip 41 is adhesively attached to and peelably removable from bottom surface 39B of narrower portion 6 of front adhesive layer 39 adjacent front end 9 so that front peel-off strip 41 entirely covers bottom surface 39B of front adhesive layer 39 and extends rearward beyond the rear of front adhesive layer 39 a short distance to serve as a finger grip which is not attached directly to another layer of strip 7 and which may be manually gripped between a finger and thumb to peel it off; and top surface 41A of rear peel-off strip 41 is adhesively attached to and peelably removable from bottom surface 39B of wider portion 8 of rear adhesive layer 39 adjacent rear end 11 so that rear peel-off strip 41 entirely covers bottom surface 39B of rear adhesive layer 39 and extends forward beyond the front of front adhesive layer 39 a short distance to serve as a finger grip which is not attached directly to another layer of strip 7 and which may be manually gripped between a finger and thumb to peel it off.

Top surface 7A comprises and in the exemplary embodiment is made up entirely of top surface 29A of layer 29, top surface 30A of layer 30, and the top surface of intermediate portion 10, namely the exposed portions of top surface 31A of conductive layer 31 and top surface 33A of layer 33. When front and rear peel-off strips 41 are attached to the front and rear adhesive layers 39, bottom surface 7B comprises and in the exemplary embodiment is made up entirely of bottom surface 41B of front layer or peel-off strip 41, bottom surface 41B of rear layer or peel-off strip 41, and the portion of bottom surface 37B of layer 37 which extends from the rear of front peel-off strip 41 to the front of rear peel-off strip 41. When front and rear peel-off strips 41 are removed from the front and rear adhesive layers 39, bottom surface 7B comprises and in the exemplary embodiment is made up entirely of bottom surface 39B of front adhesive layer 39, bottom surface 39B of rear adhesive layer 39, and the portion of bottom surface 37B of layer 37 which extends from the rear of front layer 39 to the front of rear layer 39.

The dielectric or insulation layers of strip 7 may be formed of polyethylene, polyester or other materials such as a plastic material. Dielectric layers 29, 30, 33, 35 and 37 may be formed of the same material or different materials. In some cases, strengthening layer 37 is formed of a material which is different than and may be more tear resistant than the material of which one or more of layers 29, 30, 33 and 35 are formed.

Conductor 13 is formed on conductive layer 31 that is located between the front upper insulation layer 29 and a middle insulation layer 33. Conductive layer 31 could be aluminum or any other conductor or printed ink as previously noted. In some configurations, conductive layer 31 can be etched away in manufacturing to construct the conductor and other etchings could remain to provide text or possibly an antenna. Layer 30 is located on a rear end of middle insulation layer 33 so that endpoint contacts 17 are not covered by insulation. Middle insulation layer 33 can be formed onto a strengthening layer 35 that may be a “hot melt” layer. Strengthening layer 35 may be present only near the interface with housing 3 and absent elsewhere so that if housing 3 is dropped flexible strip 7 does not too easily break off of it and generate a false alarm. Lower insulation layer 37 is placed adjacent strengthening layer 35. First end 9 and second end 11 of the lower insulation layer 37 are covered with adhesive layers 39. The adhesive layers 39 are strong enough to secure strip 7 to a box or a merchandise item to prevent removal without tearing strip 7. Removable backing layers 41 cover each of the adhesive layers 39 when the flexible strip 7 is not being used. Strip 7 may alternately be configured with one or more conductors that do not form a U-shaped loop or other open loop such that a second conductor portion or segment or conductor link which is initially separate from or separable from strip 7 may later be attached to the one or more conductors on strip 7 to complete a U-shaped loop or other open loop. The attachment point between such a conductor of strip 7 and the second conductor portion or conductor link may be a weak point for breaking the loop/circuit during tampering. One example of such an alternate configuration provides a pair of strip conductors or traces (such as legs 20A and 20B without base 15) which begin in central portion 10 of strip 7 and then abruptly end at first end 9 of strip 7 at endpoints which are axially spaced from one another. Each of the two strip electrical conductors has a strip contact area such as endpoint/contact area 17 wherein one of the two strip electrical conductors is electrically connected to one of the strip contact areas and the other of the two strip electrical conductors is electrically connected to the other of the strip contact areas. The conductor link may be connected, for example, to the pair of conductors (such as separate legs 20) to complete a continuous electrical path between contact areas such as contact areas 17. Whatever the specific configuration, the strip electrical conductors do not form a continuous electrical path between the two contact areas, and thus a separable conductor link is configured to complete a continuous electrical path between the two contact areas.

A label including the second conductor portion may, for example, be pre-attached on a merchandise item so that when strip 7 is secured to the merchandise item and/or label, the label may be folded over and sealed so that the second conductor portion contacts the conductor legs on strip 7 to form a U-shaped loop analogous to conductor 13. Of course, conductor 13 can form other shapes beginning and ending at endpoint contacts 17 or other endpoints or contacts which will be part of an electrical circuit when the strip is attached to housing 3. Thus, while conductor 13 is shown formed of generally straight line segments, the conductors 13 may be formed with meandering line segments, curved line segments and/or line segments with other shapes.

Near central portion 10 of strip 7, conductor 13 terminates at endpoint contacts 17. As illustrated in FIG. 12, the two endpoint contacts or contact areas 17 respectively make electrical contact with two respective complementary contacts or contact areas 19a of two levers 19 when strip 7 is inserted into and secured to housing 3. Endpoint contacts 17 may be larger in surface area than contact levers 19 to permit some movement between housing 3 and strip 7 (e.g., when the security device is dropped on the floor or otherwise impacted) without triggering the alarm. Endpoint contacts 17 complete an electrical path with processing circuitry or alarm logic or a conductor located in housing 3 when strip 7 is secured to housing 3.

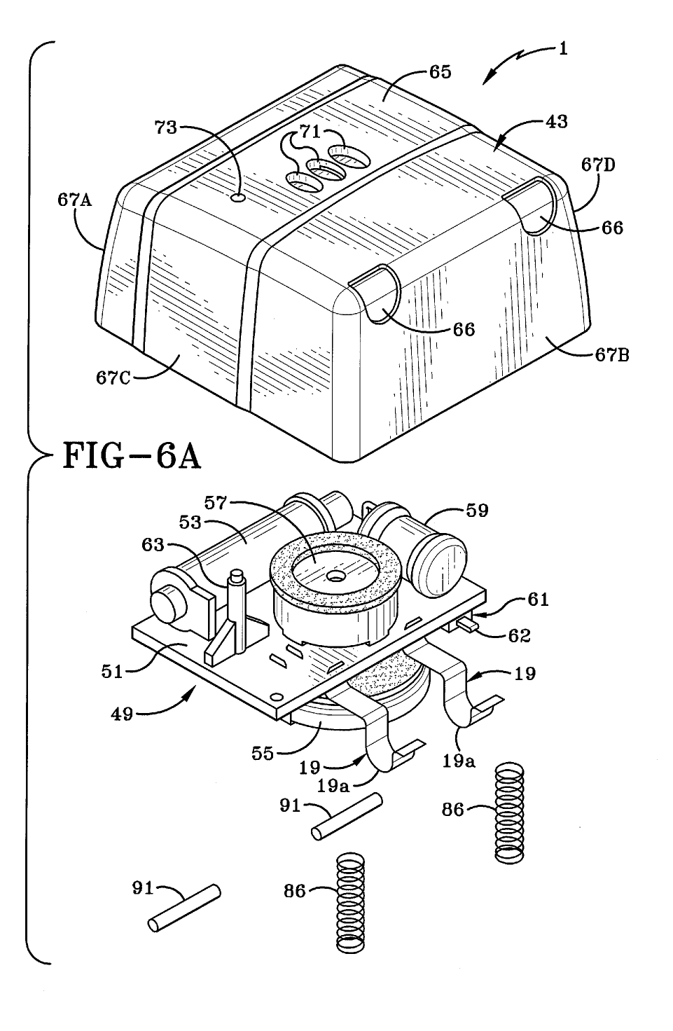

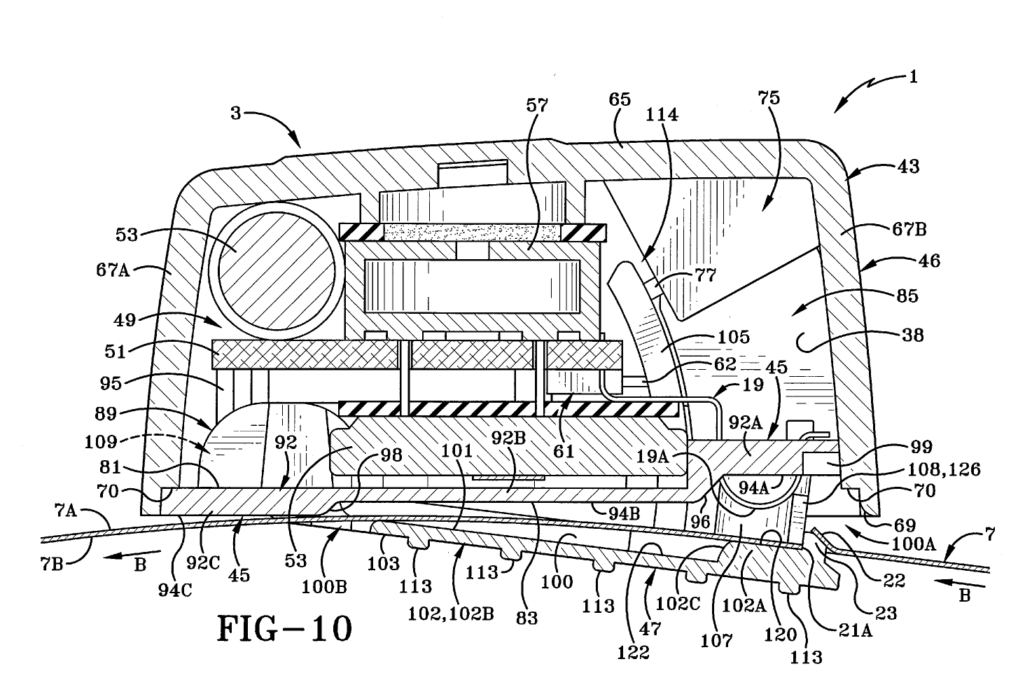

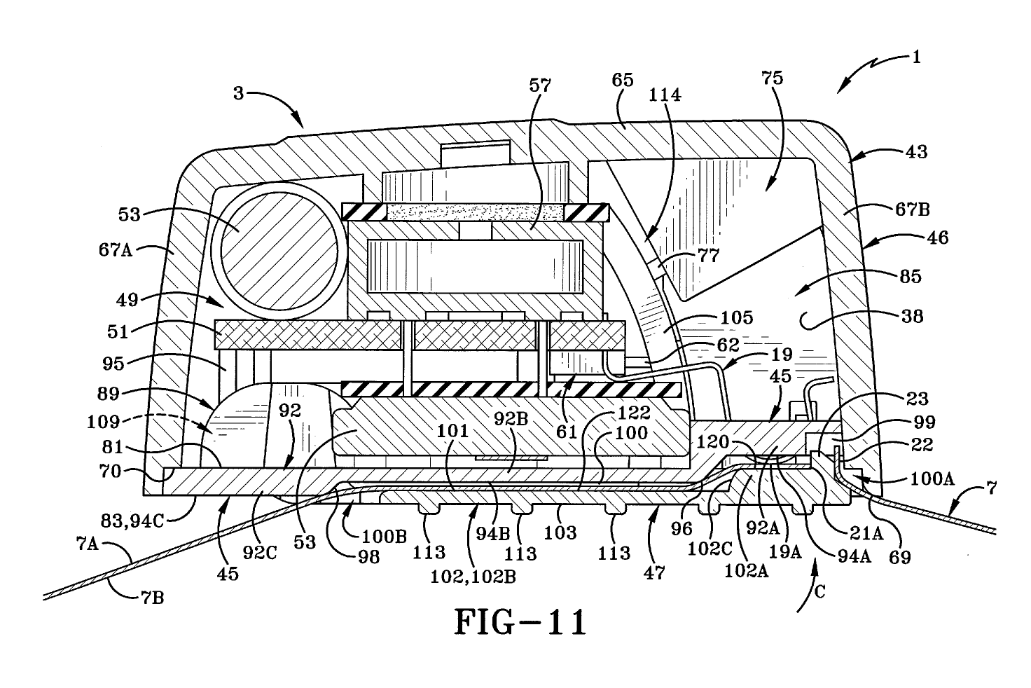

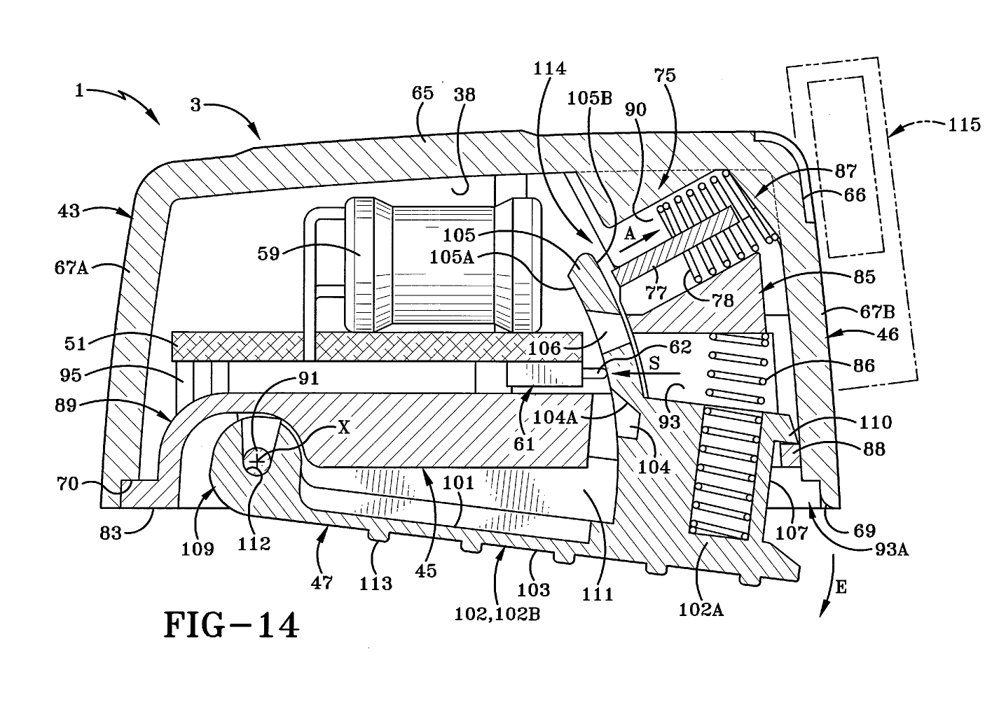

Referring primarily to FIGS. 6A/B-9, housing 3 includes a rigid upper housing 43, a rigid lower housing 45, and a rigid door 47. Upper housing 43 is fixedly secured to lower housing 45 so that upper housing 43 and lower housing 45 together form a rigid enclosure 46 (FIGS. 1, 2 and 10-14) defining an interior chamber 38 (FIGS. 10-12). Door 47 is mounted on lower housing 45 of enclosure and movable relative to enclosure 46 between an open position (FIGS. 10, 14) and a closed position (FIGS. 11-13). In the exemplary embodiment, door 47 is pivotally movable between the open and closed positions. Each of upper housing 43, lower housing 45 and door 47 may be formed a durable, high-strength plastic although other suitable rigid materials may be used. Each of upper housing 43, lower housing 45 and door 47 may be molded from plastic as an integrally formed one-piece member. Door 47 serves as a tamper strip retainer configured to retain strip 7 to housing 3.

Upper housing 43 is generally rectangular shaped and includes a generally flat rectangular or square top wall 65 and a sidewall which together partially define interior chamber 38. In the exemplary embodiment, the sidewall is rigidly secured to top wall 65 and extends downwardly therefrom, with the sidewall including four generally flat walls 67 which intersect top wall 65 along generally horizontal corners and intersect one another along generally vertical corners. Walls 67 include a front wall 67A, a rear wall 67B, a left wall 67C and a right wall 67D.

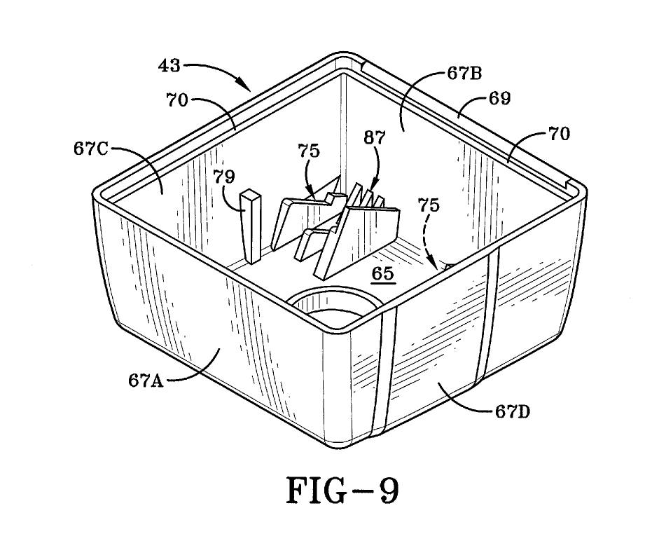

Rear wall 67B along its bottom has a straight axially elongated edge 69 (FIG. 9) which is convexly curved as viewed from the side (FIGS. 10-14) and which faces downward and forward. Rounded edge 69 helps prevent strip 7 from being torn in the area adjacent the bottom of rear wall 67B. Each of walls 67A-D has a recessed edge 70 (FIG. 9) adjacent its bottom so that lower housing 45 along its outer perimeter contacts edges 70 when received in the lower portion of the cavity defined by upper housing 43. Key location indentations 66 (FIG. 6A) are formed in upper housing 43 along the intersection of rear wall 67B and top wall 65 and are used to align a magnetic key 115 (FIG. 14) when unlocking security device 1. Speaker holes 71 are formed through top wall 65 for emitting sound from a speaker 57. Another hole 73 is formed through top wall 65 and allows a light source such as an LED to transmit light out of housing 3. In the exemplary embodiment, left and right upper support structures 75 (FIG. 9) including various rigid tapered walls which are rigidly secured to top wall 65 and rear wall 67B, extending downward from top wall 65 and forward from rear wall 67B. Support structures 75 are axially spaced from one another and are respectively adjacent the left rear corner and right rear corner of top wall 65. Upper housing 43 has one or more support/reinforcing structures or generally vertical ribs 79 which in part strengthen upper housing 43, may be rigidly secured to left and right walls 67C and 67D and extend inwardly therefrom.

With primary reference to FIGS. 6B and 8, lower housing 45 has generally an upper surface 81 and a lower surface 83 and includes a lower housing base wall 92. As shown in FIGS. 8 and 10-12, housing base wall 92 is stepped so that it includes three substantially horizontal wall segments 92A, 92B and 92C at different levels than each other. More particularly, wall 92 steps downwardly at an axially elongated step 96 from the front of rear wall segment 92A to the rear of intermediate wall segment 92B, and also steps downwardly at an axially elongated step 98 from the front of intermediate wall segment 92B to the rear of front wall segment 92C. Wall segments 92A, 92B and 92C respectively have substantially horizontal downwardly facing bottom surfaces 94A, 94B and 94C wherein intermediate bottom surface 94B is lower than rear bottom surface 94A and front bottom surface 94C is lower than intermediate bottom surface 94B, as most easily seen in FIGS. 10-12.

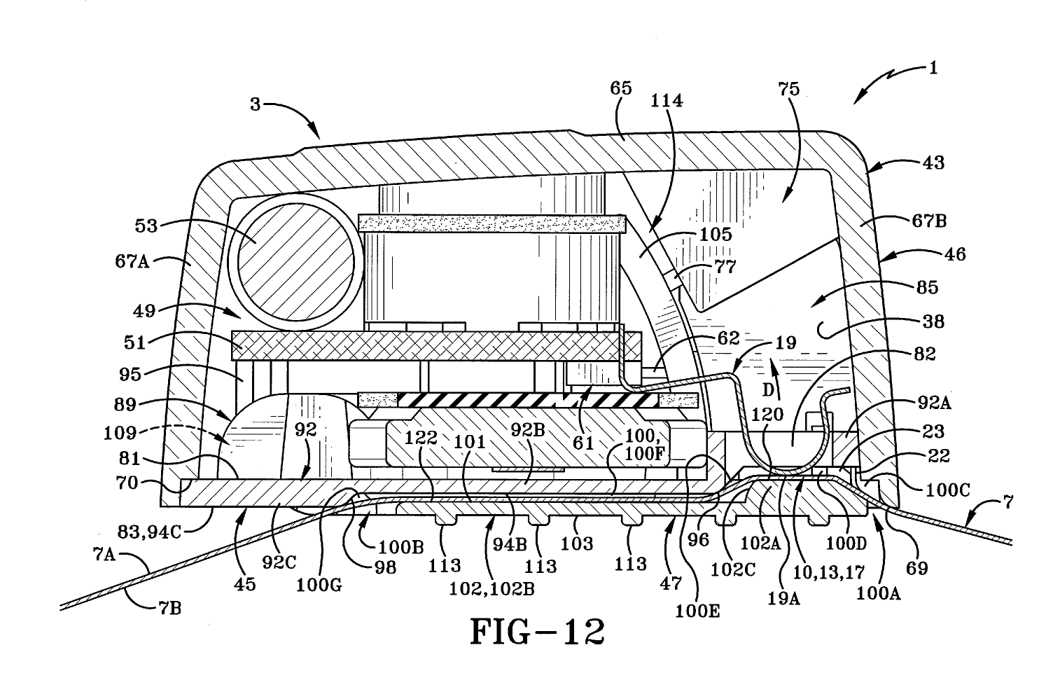

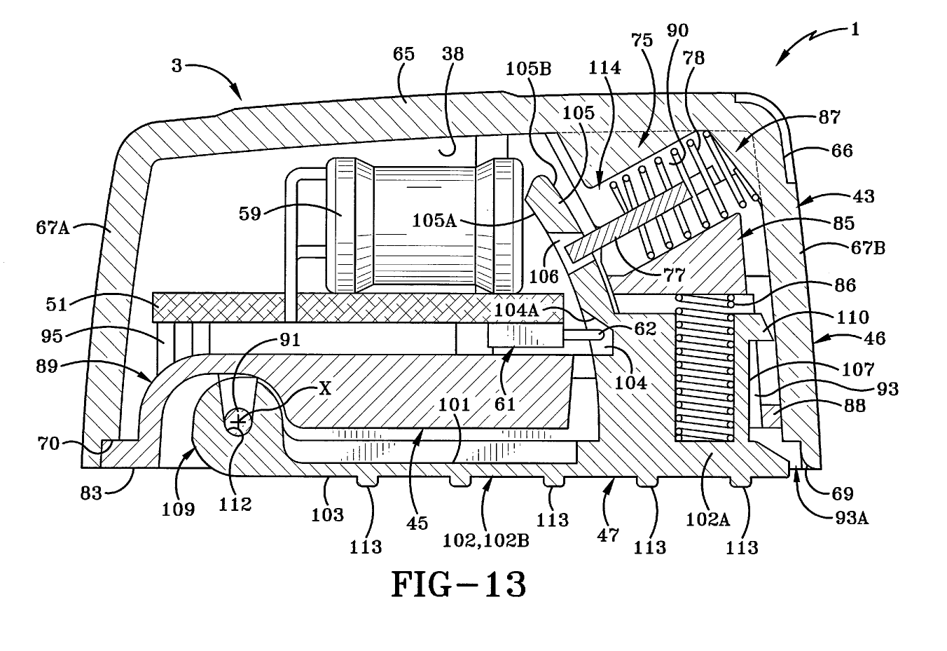

With continued reference to FIGS. 6B and 8, two lower support structures 85 are rigidly secured to and extend upwardly from base wall 92. Lower support structures 85 are axially spaced from one another and are respectively adjacent the left rear corner and right rear corner of lower housing 45. The left and right lower support structures 85 are respectively disposed directly below the left and right upper support structures 75. Thus, housing 3 includes left and right locking member mounts 87 (FIGS. 13-14) with the left mount 87 including the left upper and lower support structures 85 and 75, and with the right mount 87 including the right upper and lower support structures 85 and 75. Each mount 87 defines a locking member mounting chamber 90 between the respective upper and lower support structures 85 and 75. Below each mounting chamber 90, each lower support structure 85 defines a cavity 93 having a bottom entrance opening 93A (FIGS. 13-14). Lower housing 45 has left and right door or retainer stops 88 respectively adjacent the rear of left and right lower support structures 85 and extending rearwardly respectively from left and right cavities 93. Stops 88 are in the form of substantially horizontal upwardly facing ledges or surfaces which are adjacent the lower end of the respective support structure 85 and the lower rear of lower housing 45. Left and right door mounts 89 are formed adjacent the front end of lower housing 45 and more particularly respectively adjacent the front left and front right corners of lower housing 45. In the exemplary embodiment, each mount 89 defines a downwardly opening cavity with hinge pin receiving openings 80 extending outwardly therefrom to the left and right of each downwardly opening cavity. Lower housing 45 includes one or more upwardly projecting mounting posts 95. A tab-receiving notch 99 is formed in rear wall segment 92A adjacent the rear end of segment 92A and extending upwardly from lower surface 94A.

Left and right contact-receiving or lever-receiving through openings 82 are formed between and adjacent lower support structures 85. Left and right openings 82 extend from top surface 81 to bottom surface 83 and are formed respectively to the left and right of rear wall segment 92A with segment 92A directly between openings 82. U-shaped portions of levers 19 are received in and extend through openings 82, whereby openings 82 allow contacts 19a to engage contacts 17 strip 7 when it is installed on housing 3. Left and right locking arm receiving through openings 84 are formed in lower housing 45 respectively adjacent and directly in front of left and right support structures 85. Left and right openings 84 extend from top surface 81 to bottom surface 83 and are formed respectively to the left and right of the rear portion of intermediate wall segment 92B with the rear portion of segment 92B directly between openings 84. Left and right openings 84 are respectively directly in front of and communicate with left and right cavities 93. Left and right openings 84 thus respectively extend forward from left and right cavities 93.

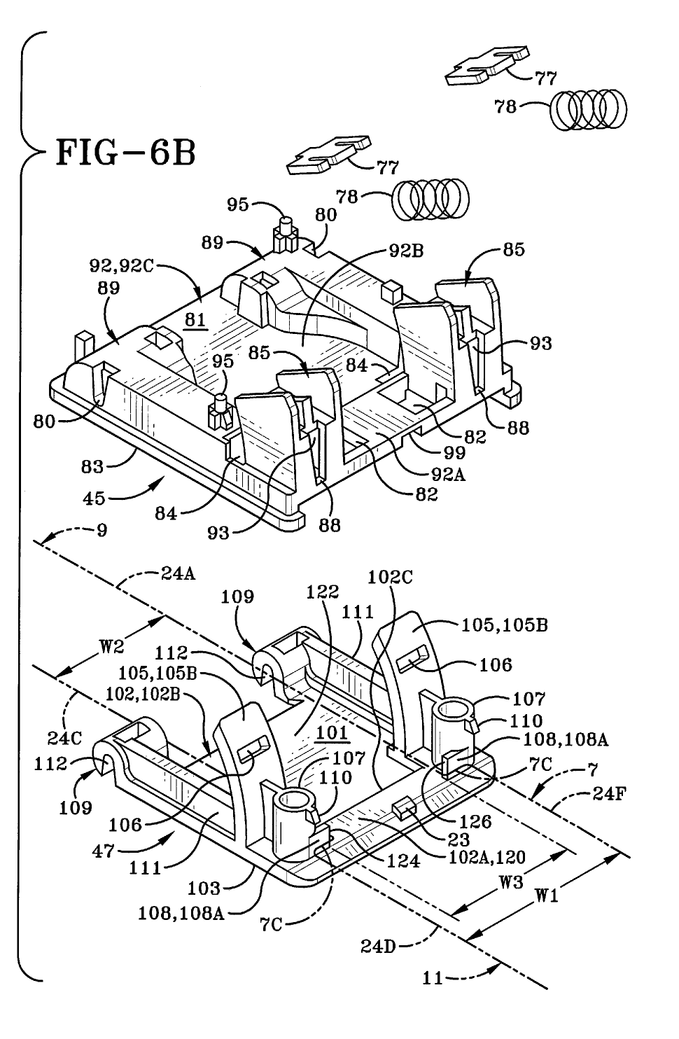

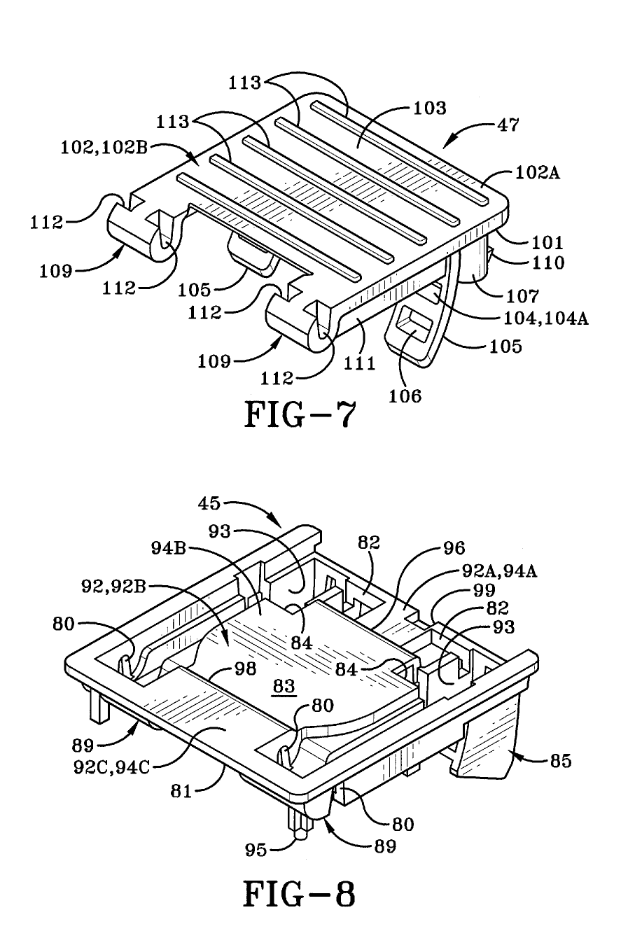

Referring primarily to FIGS. 6B and 7, door or tamper strip retainer 47 includes a door wall 102 with an upper surface 101 and a lower surface 103. Door wall 102 is stepped so that it includes two substantially horizontal wall segments 102A and 102B at different levels than each other. More particularly, wall 102 steps downwardly at an axially elongated step 102C from the front of rear wall segment 102A to the rear of rear wall segment 102B. Wall segments 102A and 102B respectively have substantially horizontal upwardly facing top surfaces 120 and 122 wherein front top surface 122 is lower than rear top surface 120, as most easily seen in FIGS. 10-12. Straight axially elongated parallel friction bars or ribs 113 (FIG. 7) are secured to and extend downwardly from the bottom of door wall 102. In use, ribs 113 engage the merchandise item and provide an improved grip on the merchandise item to help housing 3 from slipping relative to the merchandise item when secured thereto.

Door 47 includes left and right upwardly elongated arcuate locking arms 105 which are respectively to the left and right of a rear portion of front wall segment 102B and which curve upwardly and rearwardly. Each locking arm 105 has a concavely curved front surface 105A (FIGS. 13-14) and a convexly curved rear surface 105B which curve upwardly and rearwardly in parallel fashion as viewed from the side. The concavely curved front surfaces 105A and convexly curved rear surfaces 105B may be concentric about a horizontal axis X (FIGS. 13-14) about which door 47 pivots. A locking member receiving opening 106 is formed in each arm 105 extending forward from the rear convexly curved surface thereof. A plunger-receiving opening 104 (FIG. 7) is formed in one of arms 105 extending rearwardly from the concavely curved front surface 105A thereof. Opening 104 is partially defined by an angled cam surface 104A. Openings 84 receive locking arms 105 forward of and adjacent the front of structures 85, allowing arms 105 to travel there through. Opening 104 receives plunger 62 of switch 61 when door 47 is in the closed and locked position.

Door 47 includes left and right cylindrical spring mounts 107 which define cylindrical openings and are adjacent and directly rearward of left and right locking arms 105, respectively. The cylindrical openings of spring mounts 107 receive springs 86 so that a bottom end of each spring 86 abuts an upwardly facing surface of door 47 at the bottom of the respective cylindrical opening and a top end of each spring 86 abuts a downwardly facing surface of one of support structures 85. Springs 86 thus bias door 47 toward the open position. A tab or catch 110 is rigidly secured to and extends forward from the cylindrical wall of each spring mount 107. Catches 110 respectively abut stops 88 as door 47 is opened to limit how far door 47 can open or travel in the opening direction. This abutment thus defines the open position of door 47 such that the rear end of door 47 is spaced downwardly of and adjacent the bottom rear of upper housing 43, the bottom of rear wall 67B and edge 69.

Left and right pivot assemblies 109 are formed respectively adjacent the front left and right corners of door 47 and are respectively directly in front of or forward of left and right locking arms 105 and left and right spring mounts 107. Pivot assemblies 109 extend forward beyond the front end of wall segment 102B and wall 102. A hinge pin receiving opening 112 is formed in each pivot assembly 109. Parallel elongated reinforcing bars 111 extend from each pivot assembly 109 to the corresponding locking arm 105. Pivot assemblies 109 are received in the downwardly opening cavities of left and right mounts 89 and hinge pins 91 are disposed in openings 112 to pivotally mount door 47 on lower housing 45 of enclosure 46 to pivot about axis X of pins 91.

Door 47 includes left and right rearwardly facing substantially vertical stop surfaces 108A on left and right stop walls 108 (FIG. 6B) respectively adjacent left and right spring mounts 107. The left stop wall 108 and stop surface 108A extend axially to the right from adjacent the rear of the left spring mount 107. The right stop wall 108 and stop surface 108A extend axially to the left from adjacent the rear of the right spring mount 107. Left and right stop surfaces 108A may be coplanar. Left wall 108 has a substantially vertical longitudinally extending rightward facing passage-bounding edge or surface 124 which is perpendicular to left stop surface 108A and extends forward from the right end of left stop surface 108A and upwardly from top surface 120. Right wall 108 has a substantially vertical longitudinally extending leftward facing passage-bounding edge or surface 126 which is perpendicular to right stop surface 108A and extends forward from the left end of right stop surface 108A and upwardly from top surface 120. Left and right surfaces 124 are axially spaced from one another and are respectively adjacent left and right spring mounts 107 and the rear left and right corners of door 47. Surfaces 124 and 126 are directly opposite one another and face each other. Surfaces 124 and 126 define therebetween an axial distance or width W3 of a passage 100 (FIGS. 10-12). More particularly, width W3 represents the narrowest width of passage 100, which is adjacent a rear entrance opening 100A of passage 100, which is described in greater detail below.

A locking mechanism is provided within interior chamber 38 which includes left and right locks 114. Locks 114 include locking arms 105 and left and right locking members 77 (FIGS. 6B, 10-14), which may be formed on an magnetically attractable material and disposed respectively in left and right mounting chambers 90 with front ends of members 77 extend forward beyond the front of chambers 90. Each locking member 77 is movable between a forward locked position (FIG. 13) in which the front end of member 77 is received in a respective hole 106 and a rearward unlocked position (FIG. 14) in which the front end of member 77 is outside and rearward of hole 106. Left and right springs 78 (FIGS. 6B, 13, 14) are disposed in left and right chambers 90 with a rear end of each spring 78 abutting a portion of the corresponding support structure 75 and a forward end of each spring abutting the corresponding locking member 77 to spring bias member 77 forward toward the locked position.

When door 47 is in the closed position (FIGS. 11-13), springs 86 are in a compressed position, and when door 47 is in the open position, springs 86 are in an expanded position (FIG. 14) in which springs 86 are less compressed than in the compressed position, but still under compress and applying a downward force on door 47. When door 47 is in the closed position and lock 114 is in the locked position (FIGS. 11-13), springs 78 are in an expanded position or state of compression (FIG. 13) and are under compression, thus forcing the front ends of locking members 77 to remain in holes 106 absent an opposing force sufficient to overcome the spring bias of springs 78. As shown in FIG. 14, when door 47 is in the open position and lock 114 is in the unlocked position with magnetic key 115 applying a force to locking members 77 which overcomes the spring bias of springs 78, springs 78 are in a compressed position or state of compression (FIG. 13) and the front ends of locking members 77 are removed from holes 106. As shown in FIG. 10, when door 47 is in the open position and lock 114 is in the unlocked position and magnetic key 115 is not applying a magnetic force to locking members 77, springs 78 are in an intermediate position or state of compression and bias locking members 77 forward toward arms 105 so that the front ends of members 77 abut rear surfaces 1058 (FIG. 10) above holes 106.

The alarming module further comprises an onboard alarm or alarm assembly 49 mounted on housing 3 within interior chamber 38. Alarm assembly 49 includes a printed circuit board (PCB) 51 which may be mounted on posts 95 or any suitable fashion. Several components of alarm assembly 49 are mounted on PCB 51, including left and right levers 19 having left and right contacts 19a, an EAS tag 53 or other security element, a battery 55, an electronic speaker 57, a capacitor 59, a plunger switch 61, a transparent or translucent light pipe 63. PCB 51 and these various components are conveniently provided as a unit which is easily mounted in chamber 38 and eliminates wire soldering during assembly of the alarming module. EAS tag 53 may be an AM or RF type tag although any suitable EAS tag may be used. EAS tag may actuate an alarm upon passing through a security gate such as those which may be located at the exits of a retail establishment. Thus, EAS tag 53 or other security element is configured to trigger an alarm at such a security gate that generates an electromagnetic field. The actuated alarm may be adjacent the security gate and may also be a remote alarm located elsewhere. Speaker 57 may be a piezo speaker although any suitable speaker may be used. Switch 61 may be a plunger switch with a plunger 62 movable between an open and closed circuit positions. The top of light pipe 63 is received within opening 73 of upper housing 43 to allow light to be emitted there through from a light source such as an LED. Battery 55 is in electrical communication with one or more electrical conductors/circuits of PCB 51, levers 19, speaker 57, capacitor 59, switch 61 and the LED or other light source to provide electrical power to these components.

Levers 19, which are made of spring metal, and contacts 19a are movable between first or home positions (FIG. 10) in which they are at rest and second or activated positions (FIGS. 11-12) in which levers 19 are under a torque tension. Levers 19 are spring biased to their home positions. Levers 19 and contacts 19a are in electrical communication with processing circuitry or alarm circuitry/logic of PCB 51. Each lever 19 adjacent its forward end is secured to PCB 51 and extends rearwardly along a generally horizontal leg with a U-shaped segment connected to the rear end of the leg and extending downwardly therefrom. Contact 19a is at or adjacent the bottom of the U-shaped segment on a downwardly facing bottom surface convexly which is convexly curved as viewed from the side.

With primary reference to FIGS. 10-12, passage 100 and related components are now described. As noted above, passage 100 is partially defined by door 47. Passage 100 has a strip-receiving or strip-removing configuration (FIG. 10) when door 47 is in the non-securing or open position and a strip-securing configuration (FIGS. 11-12) when door 47 is in the securing or closed position.

Passage 100 is defined primarily by door 47 and lower housing 45, with the lower front portion of upper housing 43 partially defining a small portion of passage 100 adjacent entrance opening 100A. Upper surface 101 of door wall 102 and lower surface 83 primarily define therebetween passage 100 with upper surface 101 and lower surface 83 primarily serving respectively as lower and upper boundaries of passage 100. Passage 100 in the strip-securing configuration may not be straight from entrance opening 100A to exit opening 100B as viewed from the side, but rather curves or angles upwardly and downwardly along its length. When door 47 is in the closed position (FIGS. 11-12) and passage 100 in the strip-securing configuration, bottom surface 94A is adjacent and faces top surface 120, bottom surface 94B is adjacent and faces top surface 122, and step 96 is adjacent and faces step 102C.

Passage 100 includes passage segments 100C-G which are described in this paragraph in the strip-securing configuration. Segment 100C is a relatively short segment which angles upwardly and forward from entrance opening 100A and is defined between a rear angled portion of top surface 120 and the bottom of rear wall 67B. Segment 100D is a relatively short substantially straight horizontal segment which extends forward from a front upper end of segment 100B and is defined between a flat substantially horizontal portion of top surface 120 and bottom surface 94A of wall segment 92A. Segment 100E is a relatively short segment which angles downwardly and forward from the front of segment 100D and is defined between steps 96 and 102C. Segment 100F is a relatively long substantially straight horizontal segment which extends forward from a front lower end of segment 100E and is defined between bottom surface 94B of wall segment 92B top surface 122 of wall segment 102B. Segment 100G is a relatively short segment which angles downwardly and forward from the front of segment 100F to exit opening 100B and is defined between steps 98 and the forward-facing front end or edge of wall segment 102B, which serves as the front end or edge of door wall 102. Straight segment 100F is the longest of segments 100C-G, and each of angled segments 100C, 100E and 100G are shorter than segment 100D. Segments 100C, 100D and 100E together form an inverted substantially U-shaped passage segment.

Passage 100 thus provides a tortuous path for strip 7, increasing the mechanical connection between strip 7 and housing 3 when strip 7 is within passage 100 and door 47 is closed. Passage 100 includes a shallow substantially S-shaped portion. Passage 100 may be formed with a substantially more tortuous configuration than shown and thus include S-shaped or other configurations with sharper twists and turns. In addition, one or more surfaces (such as bottom surfaces 94A and 94B and upper surfaces 120 and 122) which bound passage 100 may be formed of rubber, an elastomer or other material having a coefficient of friction which is higher than the plastic of which door 47 and lower housing 45 may be primarily formed, thus strengthening the mechanical interface between strip 7 and housing 3.

In the strip-securing configuration, passage 100 may be vertically narrow or has relatively small vertical dimensions along its entire length as viewed from the side. These vertical dimensions or normal vertical widths may be substantially equal to the thickness of strip 7 or even less than the thickness of strip 7 at least in some areas. These vertical widths may also, for instance, be greater than the thickness of strip 7 and may not be more than two, three or four times the thickness of strip 7 although they may be larger. In addition, the normal width of angled portions of passage 100 may fall within the same ranges. Where a given normal width of an angled portion or normal vertical width of at least a portion of passage is less than the thickness of strip 7, door 47 and lower housing 45 may clamp strip 7 therebetween when door 47 is closed. By way of example, bottom surface 94B and top surface122 define therebetween a normal vertical width which may fall within the above-noted ranges; this may also be true of the normal vertical width defined between bottom surface 94A and top surface 120; and steps 96 and 102C may define therebetween such a normal width of angled passage segment 100E. Each of angled passage segments 100C and 100G may also have such a normal width.

It is noted that various structures of device 1 may take different forms although many of the multiple potential variations within the scope of the invention are not discussed herein. By way of example, while door 47 is pivotally mounted, an analogous door or strip retainer may be linearly movable between open and closed positions or the door/strip retainer may be a separate removable piece, or another type of door or strip retainer. Devices 200 and 300 described further below illustrate some such examples. Locks other than lock 114 may be provided for locking door or strip retainer 47 in the closed or strip-securing position. For example, a magnetic locking mechanism could be based on a spring/slug design, pin/ball clutch design, leaf spring (or multiple leaf spring) design or another design. Moreover, a non-magnetic lock may be used.

The operation of security device 1 and various relationships are now described with primary reference to FIGS. 10-14. In short, strip 7 is secured to housing 3 and adhered to a merchandise item or other article to secure device 1 to the merchandise item or article, and an alarm is generated upon an attempted defeat of device 1, particularly when conductor 13 of strip 7 is torn or otherwise severed. In securing strip 7 to housing 3, strip 7 is moved from a detached position (FIG. 3) separate from housing 3 to an attached position (FIG. 2) secured to housing 3.

In greater detail and starting with FIG. 10, while door 47 is in the open position and with front peel-off strip 41 adhered to front adhesive layer 39, strip 7 is manually moved in a forward direction (Arrows B in FIG. 10) relative to housing 3 to insert front end 9 of narrower portion 6 of strip 7 through entrance opening 100A into passage 100 and from passage 100 through exit opening 100B so that front end 9, front adhesive layer 39, front peel-off strip 41 and a length of narrower portion 6 rearward of front layer 39 and front strip 41 exit housing 3. During insertion of narrower portion 6, top surface 7A of narrower portion 6 may slidably engage bottom surface of wall 92 including one or more of bottom surfaces 94A, 94B and 94C and steps 96 and 98, while bottom surface 7B of narrower portion 6 may slidably engage top surface 101 of wall 102 including one or more of top surfaces 120 and 122 and step 102C. Front peel-off strip 41 remains adhered to front adhesive layer 39 as narrower portion 6 is moved through passage 100 so that front adhesive layer 39 does not come into contact with the housing, especially the surfaces of housing 3 defining passage 100. Rear peel-off strip 41 may remain adhered as well or be removed during insertion of strip 7, as discussed further below. Generally, front and rear adhesive 39 is not adhered to housing 3 and is intended to be adhered only to the merchandise item.

Strip 7 is slid into housing 3 through passage 100 until left and right shoulders or stops 7C respectively engage left and right stop surfaces 108A of walls 108 (as shown in FIG. 6B) and/or until alignment tab 23 reaches and is pushed through precut alignment area 21 of strip 7. Wider portion 8 cannot pass through entrance opening 100A and thus cannot enter or pass through passage 100. Pushing tab 23 upwardly and/or strip 7 downwardly when tab 23 is aligned with flap 22 causes the front of flap 22 to move upwardly via pivotal movement as the rear of flap 22 bends, thus widening the U-shaped slit to a generally semicircular opening. When tab 23 is received in hole 21, back edge 21A of the precut area contacts or be closely adjacent the front of alignment tab 23.

Each of shoulders 7C and tab 23 serve as alignment components of respective alignment features used to align endpoints or contacts 17 with (directly below) lever contacts 19. More particularly, one of the alignment features includes tab 23 and hole 21. When tab 23 is received in hole 21, strip 7 is located or positioned with contacts 17 aligned with contacts 19. More particularly, because the inner perimeter defining hole 21 is only slightly greater than the outer perimeter of tab 23, axial and longitudinal movement of strip 7 is very limited and essentially eliminated. Since the left and right sides of the inner perimeter defining hole 21 abut or are closely adjacent the left and right sides of tab 23, axial movement of strip 7 is very limited and essentially eliminated. Likewise, since the front and back of the inner perimeter defining hole 21 abut or are closely adjacent the front and back of tab 23, longitudinal movement of strip 7 is very limited and essentially eliminated.

Alternately or in addition, another alignment feature includes shoulders 7C, stop surfaces 108A, left and right edges 24A and 24C of narrower portion 6, and surfaces 124 and 126 of walls 108. Because width W3 is only slightly greater than width W2, axial movement of strip 7 is very limited and essentially eliminated when narrower portion 6 is in passage 100 since edge 24A abuts or be closely adjacent surface 124 whereby abutment of left edge 24A with surface 124 prevents leftward movement of strip 7 and edge 24B abuts or be closely adjacent surface 126 whereby abutment of right edge 24A with surface 126 prevents rightward movement of strip 7. In addition, abutment of front edges or shoulders 7C of wider portion 8 with stop surfaces 108A prevents forward longitudinal movement of strip 7. Generally, the alignment feature may include a surface of the housing and a surface of the strip which is engageable with the surface of the housing to limit movement of the strip relative to the housing in (at least) the axial or longitudinal direction, and include another such housing surface and strip surface engageable with the housing surface to limit such strip movement in the other of the axial and longitudinal directions.

Once strip 7 is inserted to its aligned position as noted above, door 47 is moved from the open position of FIG. 10 to the closed position of FIG. 1. More particularly, the rear of door 47 is pivoted in the direction of Arrow C (upwardly when housing 3 is upright) about axis X (FIGS. 13-14) of hinge pins 91 to move door to the closed position and automatically lock door 47 in the closed position. During the process of closing door 47, alignment tab 23 may be pushed into or further through opening 21 of strip 7 and at least partially into notch 99. When tab is received in notch 99 with door 47 in the closed and locked position, the engagement between rearward facing edge 21A and tab 23 blocks or prevents rearward removal of strip 7. In addition, door 47 and lower housing 45 may clamp strip 7 therebetween to secure or help secure strip 7 to housing 3. Moreover, the tortuous passage 100 and/or the use of rubberized surfaces or other surfaces with a relatively high coefficient of friction may engage strip 7 and prevent or help prevent removal of strip 7 from passage 100.

This paragraph describes various movements or changes of state which occur as door 47 is moving from the open position to the closed position. Rear surfaces 105B of left and right locking arms 105 respectively slidably engage the front ends of left and right locking members 77 until holes 106 respectively align with locking members 77 and the front ends of members 77 move into respective holes 106 by force of springs 78 on members 77, thus providing for the automatic locking noted above, which occurs simply by closing door 47. Each spring 86 is compressed upwardly between door 47 and a downwardly facing surface of one of support structures 85, thus moving from an expanded position in the open and unlocked position (FIG. 14) to a compressed position in the closed and locked position (FIG. 13). Passage 100 becomes smaller in the vertical dimension, especially adjacent rear entrance opening 100A. Wall segment 102A moves upwardly toward wall segment 92A and contacts 19a. Exposed contacts 17 of conductor 13 move upwardly toward and into contact with contacts 19a and push contacts 19a upwardly (Arrow D) a short distance, causing levers 19 to flex upwardly against the spring bias of levers 19 from their respective home positions to their respective activated positions, in which levers 19 apply a downward spring force through contacts 19a onto contacts 17. Front surface 105A of locking arm 105 slidably engages plunger 62 of switch 61 until opening 104 aligns with plunger 62 so that spring biased plunger 62 extends/is pushed by its internal spring rearward into opening 104, thereby changing the state of switch 61.

When the two contacts 17 respectively come into contact with or connect with the two contacts 19a, an electrical path/circuit is closed which includes conductor 13 and the conductor in housing 3 comprising levers 19, and conductive material of PCB 51 which may include the processing circuitry or alarm logic. The closed circuit forms a sense loop which is monitored by the processing circuitry or alarm logic as to whether it is in an open or closed circuit state. The bottom surfaces of contacts 19a engage the upper surface of contacts 17. Alternate contacts analogous to contacts 19a may take other forms. For instance, these contacts may be formed on a small metal or other electrically conductive piece mounted on a coil spring so that the contacts are also spring biased into engagement with contacts 17 of conductor 13. Alternately, such contacts may be in the form of pins which pierce contacts 17 and thus not simply rest on the top surfaces of contacts 17.

In the exemplary embodiment, security device 1 will arm when processing circuitry or logic on PCB 51 detects both that plunger 62 is in an extended position and contacts 19a have completed the electrical circuit by engaging contacts 17 of conductor 13, thus when door 47 is close . After alarm assembly 49 is armed, assembly 49 will generate an audible alarm when conductor 13 on strip 7 is torn or otherwise severed while door 47 is closed (such as when a potential thief attempts to remove strip 7 from the merchandise item or housing 3, as described previously). Severing conductor 13 opens or breaks the circuit or sense loop. The processing circuitry or alarm logic of PCB 51 senses the change from a closed circuit to an open circuit and in response causes speaker 57 to emit the audible alarm. The processing circuitry is configured to detect an electrical discontinuity between the two electrical contacts 17 or between the two electrical contacts 19a, wherein the electrical discontinuity occurs due to a severing of the electrical conductor of the tamper strip. The processing circuitry is also configured to trigger a local alarm such as alarm 49 in response to detecting the electrical discontinuity. The processing circuitry is further configured to detect attachment of the tamper strip to housing 3 by detecting electrical connectivity between the two electrical contacts 19a or between the two electrical contacts 17; to detect a closure of strip retainer 47, that is, moving to the closed position; to transition device 1 into an armed state in response to at least detecting closure of strip retainer 47 and detecting electrical connectivity between the two electrical contacts 19a or between the two electrical contacts 17; and to detect a signal in a security element such as EAS tag 53 that is induced by an electromagnetic field generated by a security gate, and to trigger a local alarm such as alarm 49 in response to detecting the signal.

This paragraph describes various relationships when strip 7 is in the secured position with door 47 in the closed position (FIGS. 2, 11-12). Bottom surfaces 94A and 94B of wall 92 and steps 96 and 98 abut or are closely adjacent top surface 7A of narrower portion 6, and the top surfaces 120 and 122 of wall 102 and step 102C abut or are closely adjacent bottom surface 7B of narrower portion 6. Intermediate portion 10 is in passage segment 100D adjacent entrance opening 100A directly below bottom surface 94A, the U-shaped portions of levers 19 and contacts 19a, with left and right contacts 19a respectively directly above and contacting top surface 31A of left and right endpoint contacts 17. Top surface 120 of wall segment 102A serves as a strip and contact support or backing member which supports a portion of strip 7 and contacts 17 as the spring biased contacts 19a are pressing against contacts 17. Front end 9 of strip 7, a portion of conductor 13 and a portion of narrower portion 6 make up a front external portion of strip 7 which extend forward beyond exit opening 100B and the front of housing 3/front wall 67A. Back end 11 of strip 7 and the vast majority of wider section 8 make up a rear external portion of strip 7 which extends rearward beyond entrance opening 100A and the back of housing 3/rear wall 67B. Thus, strip 7 extends outwardly from housing 3 in opposite directions with front and rear ends distal housing 3. In the exemplary embodiment, inasmuch as rear end 31F of conductor is either within passage 100, forward of or adjacent entrance opening 100A and the back of housing 3/rear wall 67B, either no portion of conductor 13 extends out of housing 3 through and rearward beyond entrance opening 100A and the back of housing 3/rear wall 67B or only a very short portion of conductor 13 does so. (However, strip 7 may be configured differently with a conductor which extends further toward or adjacent rear 11 such that the conductor would extend substantially beyond and rearward of entrance opening 100A and the back of housing 3.)

FIG. 14 shows the unlocking of lock 114 and device 1 by positioning a magnetic key 115 in proximity of indentations 66 on housing 3, whereby one or more magnets of key 115 magnetically attract locking members 77 toward key 115 so that the front ends of locking members 77 are removed from holes 106 and springs 78 are compressed. With locking members 77 removed from holes 106 and possibly disengaged from locking arms 105, springs 86 force door 47 to pivot open with the rear of door 47 moving downward (Arrow E). While door 47 is moving from the closed position to the open position, cam surface 104A of one locking arm 105 slidably engages plunger 62 (Arrow S) of switch 61, which causes plunger 62 to move from an extended position (FIG. 13) to a retracted position (FIG. 14). Processing circuitry or alarm logic on PCB 51 detects that plunger 62 has moved to the retracted position, thus changing the state of switch 61. The processing circuitry or alarm logic causes alarm assembly 49/device 1 to be changed to an unarmed state in response to detecting this retraction of plunger 62/change of state of switch 61.

Once door 47 is opened, plunger 62 abuts front surface 105A above opening 104, which maintains switch 61 in the unarmed position. Additionally, catches 110 of door 47 come into contact with stops 88 to prevent door 47 from further opening. Thus, when door 47 is in the open position, the rear end of door 47 is spaced downwardly from but still adjacent the lower end of rear wall 67B. After door 47 is opened, strip 7 may be removed from passage 100 so that housing 3 and strip 7 are separated from one another. Housing 3 may then be reused with another strip 7 by inserting it into passage 100 and closing door 47 as previously described. Strip 7 can be left on the merchandise item or it can be cut off or removed in another way.

Having described the operation of the various components of security device 1, its use in protecting against theft will be described with shoe 5 (FIG. 1) as the merchandise item after a brief description of shoe 5. Shoe 5 includes an upper 128, a sole 130 secured to the bottom of the upper and a heel 132 secured to the bottom of sole 130. Shoe has a toe section or front end 134 and a back end 136.

Upper 128, sole 130 and heel 132 define an outer surface 138 of shoe 5, which also has an inner surface 140 defined by an inner surface of upper 128 and the top of sole 130 or a foot pad or liner on top of sole 130. Inner surface 140 defines a foot-receiving interior chamber 142 having an entrance opening along the top of shoe 5 adjacent back end 136.

Generally, front and rear peel-off strips 41 are removed from the front and rear adhesive 139, and a force is applied on top surface 7A of strip 7 adjacent each of ends 9 and 11 to press the respective adhesive 139 onto shoe 5, thereby adhering strip 7 to shoe 5 to secure strip 7 and housing 3 to shoe 5. Rear end 11 of strip 7 may be adhered or affixed by the corresponding adhesive before or after strip 7 is secured to housing 3 in the manner previously described. Each peel-off strip 41 may be removed shortly before the respective end 9, 11 is to be fastened to shoe 5. Rear end 11 (the end without conductor 13) may be adhesively attached or affixed inside shoe 5 to inner surface 140 so that end 11 is not easily removed from inner surface 140, and front end 9 (the end with conductor 13) may be adhesively attached or affixed to outer surface 138, such as to the bottom of heel 132. As previously noted, strip 7 has a very low profile or very minimal thickness so that strip 7 does not block or essentially alter the size of entrance opening 144 of shoe 5 and thus allows a customer to insert his or her foot into chamber 142 via entrance opening 144 without bothering the customer or affecting the customer's ability to determine the fit of the shoe. Housing 3 is positioned along the side of shoe 5 abutting outer surface 138 of upper 128 entirely outside shoe 5, whereby housing 3 also does not block entrance opening 142, and no portion of housing 3 is within chamber 142 or entrance opening 142. As previously described, if a potential thief attempts to defeat device 1 such that conductor 13 is severed, alarm assembly 49 will produce an audible alarm.

When the customer is going to purchase the shoes, device 1 is unlocked with key 115 by an authorized person such as a sales person or cashier, and housing 3 is removed from strip 7. After housing 3 is removed, strip 7 may be cut or peeled off of shoe 5 either at the sales counter or elsewhere. Thus, strip 7 or a portion thereof may remain attached to shoe 5 for subsequent removal by the customer. Strip 7 is ideally low cost, since it typically goes out the door with the shopper and more generally because it may be not feasible to reuse strip 7 after it has once been attached to a merchandise item. Strip 7 is thus disposed of after use.

Although strip 7 has been discussed as mounting on shoe 5, security device 1 can also be used on boxes or any other suitable merchandise item. If desired, strip 7 may be implemented “at source,” meaning that strip 7 may be applied to an item where the item is manufactured. One end of strip 7 may, for instance, be adhered or “pre-applied” inside an end flap of a box or on another item while the item is at one location such as a manufacturing plant whereas housing 3 could later be secured to strip 7 when the item arrives at a different remote location such as a retail establishment where the item is to be sold.

Device 1 is configured to sound an audible alarm in response to the severing of conductor 13 (creating an electrical discontinuity as previously discussed) when strip 7 is secured to housing 3 and when device 1 is thus in an armed state. Such severing may occur in any number of ways, such as during an attempt to remove strip 7 and housing 3 from the merchandise item or other article, or during an attempt to remove housing 3 from strip 7. This severing may result, for example, from a potential thief or someone else pulling on and/or twisting housing 3 or strip 7, or from cutting conductor 13 with a knife, scissors or other cutting device.

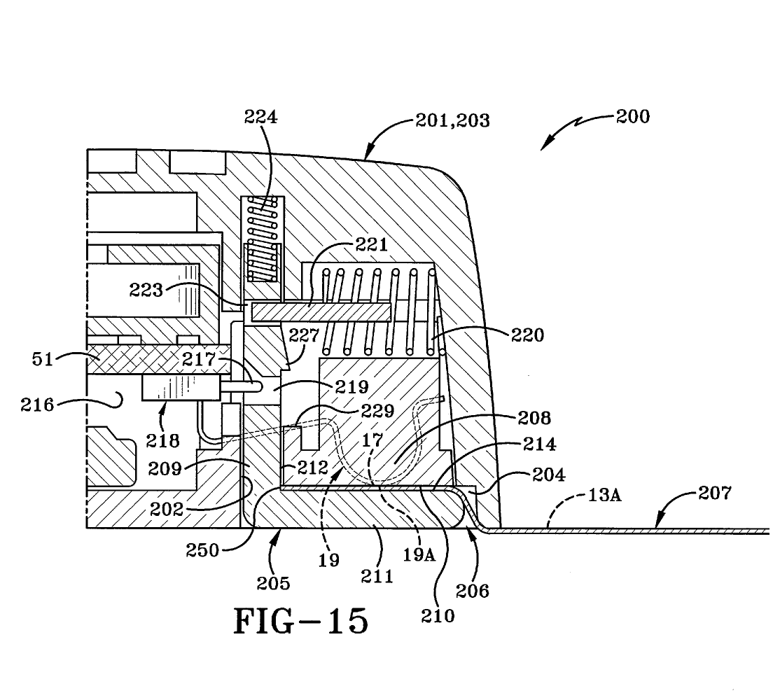

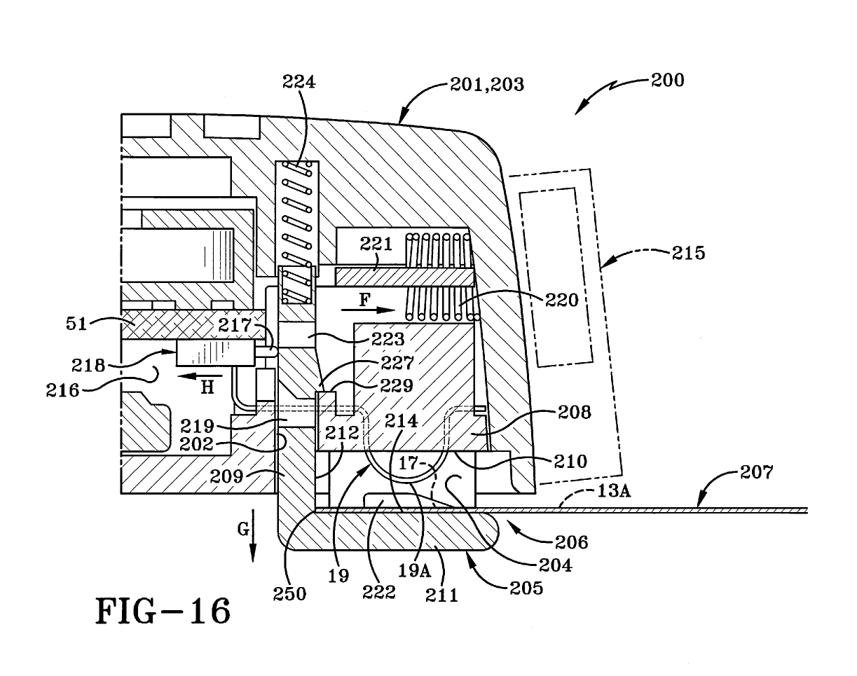

FIGS. 15 and 16 illustrate a second embodiment of a security device 200 that has a housing 201 comprising a rigid enclosure 203 and a rigid strip retainer 205 for securing a flexible strip 207 to housing 203. Strip 207 has a front end 250 and is similar to strip 7 in that it includes two or more insulation layers and an open loop conductor 13A, which similar to conductor 13, has a covered portion and an exposed portion except that conductor 13A has endpoint contacts or contact areas 17 in the exposed portion which are adjacent front end 250. One or more retaining/alignment through holes are formed adjacent front end 250 in a manner similar to opening or hole 21 in strip 7. Strip 207 also includes tear points similar to tear points 25 and/or 27 of strip 7.

Enclosure 203 defines an interior chamber 216 in which various components are disposed analogous to the components within chamber 38 of device 1. Enclosure 203 defines a vertical channel 202 and a primarily horizontal strip-receiving passage 204 having a rear entrance opening 206. Unlike passage 100 of device 1, passage 204 does not have a front exit opening and is thus a dead end passage. Enclosure includes a recessed strip-engaging and/or passage-bounding wall 208 having a horizontal downwardly facing bottom surface 210. Wall 208 includes an upwardly facing stop surface 229.

Strip retainer 205 includes a vertical locking arm 209 and a horizontal wall or platform 211 that are formed as an integral one-piece member, such as a molded plastic component. Locking arm 209 has a vertical rearward facing back surface or stop 212, and platform 211 has a horizontal upwardly facing top surface 214.

Passage 204 is primarily defined between bottom surface 210 and top surface 214. Locking arm 209 is slidably received in vertical channel 202 so that retainer 205 moves linearly up and down relative to enclosure 203 with arm 209 within channel 202 between a raised closed or securing position (FIG. 15) and a lowered open or non-securing position (FIG. 16). Locking arm 209 defines a switch hole 219 and a lock hole 223. A catch 227 extends rearwardly from arm 209 and has a downwardly facing bottom surface. A spring 224 is positioned in chamber 216 above the top of locking arm 209 engaging an upwardly facing surface thereof and biases strip retainer 205 downwardly to the open position. One or more locking tabs 222 are mounted on platform 211 and extend upwardly a short distance from top surface 214.

An alarm assembly similar to alarm assembly 49 is mounted within interior chamber 216 and includes PCB 51 with two levers 19 mounted thereon having two respective contacts or contact areas 19a. A plunger switch 218 is mounted within interior chamber 216 and includes a plunger 217 movable between a retracted first position (FIG. 16) and an extended second position (FIG. 15). A lock is provided in chamber 216 including a locking member 221, a spring 220 and locking arm 209. The lock has a locked position (FIG. 15) in which locking member 221 is received in opening 223 and an unlocked position (FIG. 16) in which member 221 is removed from opening 223.

In use, front end 250 of strip 207 is inserted into passage 204 through entrance opening 206 when retainer is in the open position until front end 250 abuts stop 212 and/or tab or tabs 222 is/are received in the hole or holes formed in strip 207 adjacent front end 250. The tabs 222 and holes provide an alignment feature for aligning strip 207 properly within passage 204 with the two complementary contacts or contact areas 17 aligned directly below contacts 19A. Retainer 205 is then moved from the open to the closed position to automatically lock retainer 205 in the closed position and to secure strip 207 to housing 201. In the closed and locked positions, the top surface of strip 207 abuts or is closely adjacent bottom surface 210 and the bottom surface of strip 207 abuts or is closely adjacent top surface 214. Strip 207 may be clamped between surfaces 210 and 214. Tabs 222 in the holes in strip 207 also serve as a strip-retaining feature which prevents strip 207 from being removed from passage 204 and thus from housing 201.

Closing retainer 205 also brings contacts 17 of strip 207 into engagement with contacts 19a, thus forming a conductive path or sense loop as discussed with respect to device 1. In addition, plunger 217 moves to an extended position into opening 219. Processing circuitry or alarm logic on PCB 51 detects the resulting change of state of switch 218 and arms or activates alarm circuitry in the same manner discussed previously. Further, locking member 221 moves into opening 223 under force of spring 220, thus providing the automatic locking of retainer 205 by simply closing retainer 205. Strip 207 may an include an adhesive or other securing mechanism by which strip 207 is secured to a merchandise item or other article, thereby also securing housing 201 to the merchandise item or article when housing 201 is secured to strip 207. In the armed or activated state, the processing circuitry or alarm logic will generate an appropriate alarm if conductor 13A on strip 207 is torn or otherwise severed (as by a potential thief), like alarm system of device 1 discussed above.

FIG. 16 shows the unlocking of device 200 with a magnetic key 215 which is positioned adjacent housing 203 so that a magnet of key 215 magnetically attracts locking member 221 (Arrow F) away from locking arm 209 and out of hole 223, thereby compressing spring 220. This allows spring 224 to expand and force strip retainer 205 downwardly (Arrow G) usually until the bottom of catch 227 comes into contact with stop 229, whereby spring 224 thus automatically moves retainer 205 to the open position when locking member 221 is moved to the unlocked position by key 215. Downward movement of locking arm 209 also causes plunger 217 to move to its retracted position via a cam surface of locking arm 209. The processing circuitry or alarm logic senses that contacts 17 and 19a are disengaged and plunger 62 is in the retracted position, and thus causes the alarm assembly to be unarmed or deactivated. In the open position, strip 207 can be lifted off tabs 222 and removed from passage 204 and housing 201. Housing 203 can then be reused with another strip 207.

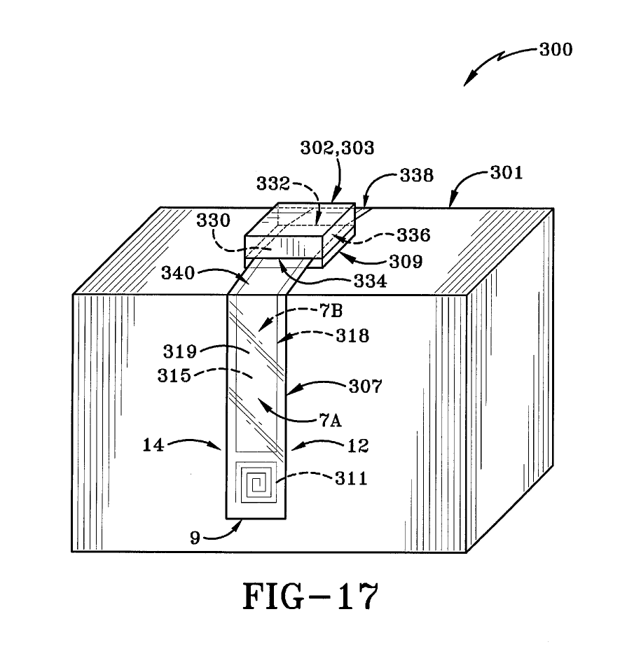

FIGS. 17-20 illustrate a security device 300 which is configured to attach to a box 301 containing a merchandise item or to another merchandise item. The primary components of this embodiment are a housing 302 which comprises a rigid enclosure 303 and a rigid strip retainer 309, and a thin flat flexible security sheet or tamper strip 307 which is removably attachable to housing 302 and is similar to strip 7 of device 1 with some variations. Enclosure 303 is similar to housing 3 of security device 1 and defines an interior chamber which contains an alarm assembly which is similar to that of alarm assembly 49 of device 1 and functions in a similar manner.

Strip 307 has first and second, or front and rear ends 9 and 11 between which strip 307 is elongated and which define therebetween a longitudinal direction of strip 307. Strip 307 has first and second sides 12 and 14 defining therebetween an axial direction of strip 307. The longitudinal and axial directions apply also to device 1 and housing 3. Strip 307 has an upwardly facing top surface 7A and a downwardly facing bottom surface 7B defining therebetween a thickness which in the preferred embodiment, may, but need not be a few mils (thousandths of an inch) thick. Strip 307 is substantially rectangular as viewed from above. Strip 307 may include, adjacent front end 9 or elsewhere, a deactivatable RF label 311 or an RFID tag that can contain information about a product to which strip 307 is attached.

Strip 307 includes an electrical conductor 318 which forms part of a sense loop when strip 307 is secured to housing 302. Conductor 318 is similar to conductor 13 of strip 7 with some variation. Conductor 318 may be formed in generally the same manner as described with respect to conductor 13, that is, it may be a trace and is typically a thin flat layer. Conductor 318 forms an open loop with a pair of endpoint contacts or contact areas 320 at the beginning and end of the open loop. Conductor includes a left longitudinal segment 304 extending along left side 12 from adjacent front end 9 to adjacent back end 11, front and back axial end segments 305A and 305B respectively adjacent front and back ends 9 and 11, and front and back longitudinal right side segments 306A and 306B. End segments 305A and 305B respectively extend to the right from the front and rear ends of segment 304, while front side segment 306A extends rearward from the right end of front segment 305A to front contact 320, and rear side segment 306B extends forward from the right end of rear segment 305A to rear contact 320.

With primary reference to FIG. 19, strip 307 has one or more adhesive layers or zones 315, a bottom dielectric or insulation layer 317, an electrically conductive layer 323 which forms conductor 318 in the exemplary embodiment, an adhesive layer 321 and a dielectric or insulation top layer 319. The insulation layer 317 and 319 may be formed of a thin polyester or polyethylene film or another suitable material such as a plastic material. Each of the layers of strip 307 has parallel flat top and bottom surfaces. Thus, the bottom surface of top layer 319 is secured to the top surface of adhesive layer 321; the bottom surface of adhesive layer 321 is secured to the top surface of conductive layer 323; the bottom surface of conductive layer 323 is secured to the top surface of bottom layer 317; and the bottom surface of bottom layer 317 is secured to the top surface of the one or more adhesive layers or zones 315. Although not shown, one or more peel-off strips similar to strips 41 of strip 7 are usually attached to and entirely cover the one or more bottom surfaces of the one or more adhesive layers 315 and are peelably removable therefrom. Although layers 319 and 323 are shown adhesively secured to one another by adhesive layer 321, they may be secured in any other suitable manner. For example, layers 319 and 323 may be heat sealed to one another whereby the bottom of layer 319 contacts the top of layer 323. A pair of top layer contact-exposing through holes 322 are formed in top layer 319 and disposed directly above contacts 320 so that contacts 320 are exposed and thus form a part of top surface 7A of strip 307. Top layer 319 may serve as all of top surface 7A except for contacts 320 and any small portion of other layers which may be exposed by holes 322. Top layer 319 thus may cover all of conductor 318 except for contacts 320 and any relatively small portions of conductor 318 adjacent contacts 320. Conductor 318/layer 323 has a covered portion between layers 317 and 319 and an exposed portion which is not between layers 317 and 319, namely at holes 322 where a portion of conductor 318 including contacts 320 is exposed. In this covered portion, strip 307 includes layers 317 and 319 and the exposed portion includes layer 317 and does not include layer 319. Top layer 319 and adhesive layer 321 may be transparent or translucent so that conductor 318 is visible through layer 319, thereby acting as a deterrent to theft. Conductor 318/conductive layer 323 is disposed between or extends between bottom layer 317 and top layer 319. More generally, as is true of the conductors and layers of strips 7 and 207, conductor 318 is disposed between or extends between two dielectric or insulation layers, and the strip may include additional layers.

Strip 307 may include tear points similar to those discussed with respect to strip 7 although they may be formed in other locations. For instance, tear points may be formed adjacent both ends 9 and 11 inasmuch as conductor 318 extends from adjacent end 9 to end 11. Moreover, tear points may be formed at various other locations on strip 307 suitable to their purpose.

Enclosure 303 has a downwardly facing generally horizontal bottom surface 310. A plurality of alignment holes 314 are formed in enclosure 303 extending upwardly from bottom surface 310. A pair of electrically conductive contacts 316 are mounted on enclosure 303 and extend downwardly from bottom surface 310. Strip retainer 309 has an upwardly facing generally horizontal top surface 312. A plurality of alignment tabs 313 extend upwardly from top surface 312.

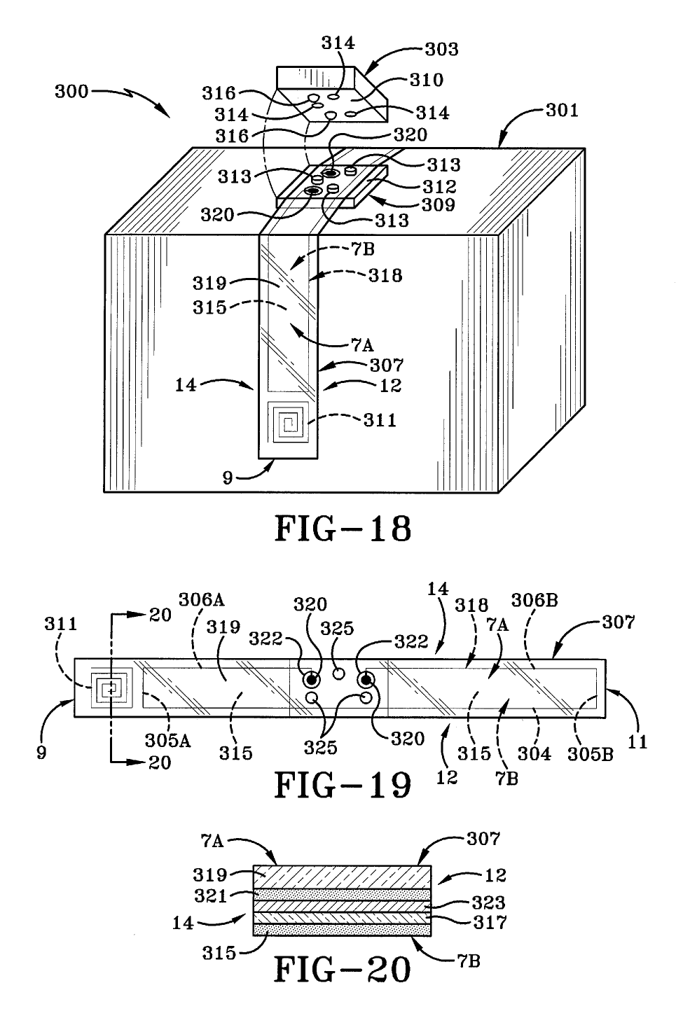

Strip retainer 309 and enclosure 303 are movable relative to one another between a closed or securing position (FIG. 17) and an open or non-securing position (FIG. 18). A lock, such as the locks of devices 1 and 200 or any other suitable lock, is provided having a locked position to lock enclosure 303 and retainer 309 to one another in the closed position and an unlocked position allowing enclosure 303 and retainer 309 to move from the closed to the open position. The lock is unlocked by a key as previously described with respect to devices 1 and 200.

In the closed position and locked position, tabs 313 are received respectively in holes 314 and contacts 316 engage contacts 320 to close an electrical circuit, forming an electrical path or sense loop which may include processing circuitry or alarming logic of PCB 51 of an alarm assembly which is similar to and functions in essentially the same manner as alarm assembly 49 of device 1. Tabs 313, holes 314 and holes 325 together form an alignment feature which aligns strip retainer 309 with enclosure 303, which aligns strip 307 with strip retainer 309 and enclosure 303, and which aligns contacts 316 with contacts 320. In the exemplary embodiment, there are three tabs 313 and three hole 314, thereby creating a one-option or one-way alignment feature which only allows strip 307, retainer 309 and enclosure 303 to be aligned in one way. That is, each of these three components must be aligned properly because the three tabs 313 will only fit into holes 325 in one way and will only fit into holes 314 in one way. Such a one-way alignment feature may be formed with any number of tabs and holes, although specifically shaped tab and hole may be needed where only a single tab and hole is used. In the closed position, bottom surface 310 and top surface 312 define therebetween a strip-receiving passage 330 having a rear entrance opening 332 and a front entrance opening 334. In the closed and locked positions, top surface 7A and bottom surface 7B of an intermediate portion of strip 307 respectively abut or are closely adjacent bottom surface 310 of enclosure 303 and top surface 312 of retainer 309.

In use, strip 307 is positioned on retainer 309 so that alignment holes 325 receive therein alignment tabs 313 to align strip 307 with retainer 309 in a position in which an intermediate portion 336 of strip 307 will be within passage 330 and contacts 320 are correctly positioned to be contacted by contacts 316 when enclosure 303 and retainer 309 are in the closed position. Strip 307 is secured to box 301 or any given merchandise item with adhesive 315, thus securing strip 307 and retainer 309 to box 301, and also securing enclosure 303 to box 301 when it is secured to retainer 309. Enclosure 303 is moved to the closed position and locked to retainer 309 with the lock, thereby securing enclosure 303, retainer 309 and strip 307 together and defining passage 330. In these closed and locked positions (FIG. 17), internal intermediate portion 336 of strip 307 is within passage 300, an external rear portion 338 of strip 307 extends rearward out of and beyond rear entrance opening 332 and the back of housing 302, and an external front portion 340 of strip 307 extends forward out of and beyond front entrance opening 334 and the front of housing 302.

Strip 307 may be of any length suitable for the merchandise item to which it is to be attached. In the example, front end 9 of strip 307 is adhesively attached to a first or front side of box 310 which may be vertical and rear end 11 of strip 307 is adhesively attached to an opposite second or back side of box 310 which may be vertical and/or parallel to the first side, with housing 302 on top of box 301 and the bottom of retainer 309 abutting the top surface of box 301, which may be horizontal. However, the ends of strip 307 may be attached to any surface of box 301 or other merchandise item and strip 307 may be attached to box 301 or other item in another manner.

If desired, strip 307 may first be attached to box 301 by adhering both ends 9 and 11 to box 301, after which strip retainer 309 may be slid under an intermediate portion of strip 307 which is not adhesively attached to box 301 so that alignment tabs 313 are received in alignment holes 325. Strip retainer 309 and strip 307 may, for example, be attached at a distribution center. Box 301 with strip 307 attached thereto may be transported to a retail establishment where retainer 309 and enclosure 303 are attached to strip 307, or box 301 with strip 307 and retainer 309 attached thereto may be transported to a retail establishment where enclosure 303 is attached to strip 307 and retainer 309.

Regardless of the exact procedure of securing device 300 to box 301 or another article, device 300 provides protection against theft of box 301 and its contents or any article or item to which it is attached in a manner similar to devices 1 and 200. That is, an attempt to defeat device 300 in the manner previously described with respect to devices 1 and 200 will result in conductor 316 being torn or otherwise severed, thus producing an audible alarm in the same or a similar manner.

Thus, each of devices 1, 200 and 300 may be mounted on a shoe, box, or various other articles or merchandise items and provide protection against theft thereof. Each of these devices may be, but need not be configured to not pierce or puncture any article to which it is attached, and may, but need not be attached using an adhesive on its strip. Thus, these devices may, but need not include a pin, tack or other sharp structure which pierces or punctures the item or article when attached thereto. The tamper strip of each of these devices may, but need not extend all the way around the merchandise item or article to which the device is secured. Similarly, the combination of tamper strip and housing of each of these devices may, but need not extend all the way around the merchandise item or article to which the device is secured. These devices also may, but need not include a metal cable which includes wound metal strands and which, for instance, is wrapped around the item or article or is inserted through a hole in the item or article to attach the device to the item or article. In addition, these devices may, but need not include an adhesive layer or pad which is affixed to the housing and is used to attach the housing directly to a merchandise item or other article. Moreover, these devices may, but need not include a plunger switch or the like in which the plunger thereof extends outwardly from the housing and in which the plunger engages and is depressed by the merchandise item or other article when the housing is secured to the item or article.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1-20. (canceled)

21. A security device for protecting an article from theft, the security device comprising:
a housing;
a first electrical conductor in the housing having a first electrical contact;
a flat flexible tamper strip having an attached position in which the tamper strip is secured to and extends outwardly from the housing, and a detached position in which the tamper strip is separated from the housing; and
a second electrical conductor of the tamper strip having a second electrical contact which contacts the first electrical contact in the attached position.

22. The device of claim 21 further comprising an alarm in the housing.

23. The device of claim 22 further comprising an electrical circuit comprising the first and second electrical conductors; wherein the alarm is activated in response to opening the electrical circuit when the tamper strip is in the attached position.

24. The device of claim 21 further comprising:
an electrical switch in the interior chamber in electrical communication with the first electrical conductor; and
alarm logic in the housing which causes the alarm to change states between an armed state and an unarmed state in response to detecting a change of state of the switch.

25. (canceled)

26. The device of claim 21 wherein the housing comprises an enclosure and a tamper strip retainer which is movable between a securing position in which the tamper strip is secured to the housing and a non-securing position which allows removal of the tamper strip from the housing.

27. The device of claim 26 further comprising a lock having a locked position in which the lock locks the tamper strip retainer in the securing position in which the tamper strip is secured to the housing and a non-securing position which allows removal of the tamper strip from the housing.

28. The device of claims 26 wherein the tamper strip defines a locating opening; and the housing comprises a tab which is received in the locating opening in the securing position.

29. (canceled)

30. The device of claim 21 wherein the housing defines a passage configured to receive the tamper strip.

31. (canceled)

32. (canceled)

33. The device of claim 30 wherein the passage has an entrance opening and an exit opening; and in the attached position, the tamper strip has a portion in the passage, a portion extending outwardly away from the entrance opening, and a portion extending outwardly away from the exit opening.

34. The device of claim 33 wherein the passage has an entrance opening; the tamper strip is insertable into the passage through the entrance opening;
the housing has a stop surface; and the tamper strip has a stop which is engageable with the stop surface to limit insertion of the tamper strip into the passage.

35. (canceled)

36. The device of claim 21 wherein the tamper strip has a tear point adapted to encourage the second electrical conductor to be torn upon application of a removal force on the tamper strip.

37. (canceled)

38. (canceled)

39. The device of claim 36 wherein the tear point extends partially across the conductor.

40. (canceled)

41. An apparatus comprising:
a housing;
two electrical contacts mounted on the housing and positioned such that the two electrical contacts connect with respective complementary contact areas of a disposable tamper strip, wherein the disposable tamper strip is configured to be adhered to an article to be protected from theft and wherein the tamper strip includes an electrical conductor that is electrically connected to at least one of the contact areas; and
processing circuitry which is configured to detect an electrical discontinuity between the two electrical contacts, wherein the electrical discontinuity between the two electrical contacts occurs due to a severing of the electrical conductor of the tamper strip; and wherein the processing circuitry is configured to trigger a local alarm in response to detecting the electrical discontinuity.

42. The apparatus of claim 41 wherein the processing circuitry is further configured to detect attachment of the tamper strip to the apparatus by detecting electrical connectivity between the two electrical contacts.

43. The apparatus of claim 41 wherein the processing circuitry is further configured to detect a closure of a tamper strip retainer.

44. (canceled)

45. The apparatus of claim 41 further comprising a security element configured to trigger an alarm at a security gate that generates an electromagnetic field.

46. The apparatus of claim 45 wherein the processing circuitry is further configured to detect a signal in the security element that is induces by the security gate, and trigger the local alarm in response to detecting the signal.

47. The apparatus of claim 21 wherein the housing defines a passage configured to receive the tamper strip.

48-62. (canceled)

63. An anti-theft tamper strip comprising:
an adhesive for affixing the anti-theft tamper strip to an article to be protected;
an electrical conductor, wherein the electrical conductor includes two contact areas positioned to electrically connect to respective contacts of an alarming module; and
a plurality of tear points formed in the tamper strip to encourage the electrical conductor to be torn upon application of a removal force on the flexible strip.

64. The anti-theft tamper strip of claim 63 wherein the plurality of tear points include at least one tear point that extends into the conductor.
